(19) United States
(12) Patent Application Publication
(10) Pub. No.: US 2024/0103258 A1
(43) Pub. Date: Mar. 28, 2024

(54) ZOOM LENS AND IMAGE PICKUP APPARATUS

(71) Applicant: CANON KABUSHIKI KAISHA, Tokyo (JP)

(72) Inventors: Kazufumi GOTO, Tochigi (JP); Akihiko YUKI, Saitama (JP)

(21) Appl. No.: 18/464,389

(22) Filed: Sep. 11, 2023

(30) Foreign Application Priority Data
Sep. 21, 2022 (JP) 2022-149803
Jun. 23, 2023 (JP) 2023-103771

(51) Int. Cl. G02B 15/14

(52) U.S. Cl. CPC G02B 15/145; G02B 15/146

(57) ABSTRACT

A zoom lens in which a distance between adjacent lens units changes during zooming includes in order from an object side to an image side a first lens unit fixed during zooming and having positive refractive power, three or more moving lens units movable during zooming, and a final lens unit fixed during zooming and having positive refractive power. At least part of the first lens unit moves during focusing. At least one of a moving lens unit closest to an image plane among the three or more moving lens units and the final lens unit includes a first lens having positive refractive power. A predetermined condition is satisfied.

### BACKGROUND

### Technical Field

One of the aspects of the embodiments relates to a zoom lens and an image pickup apparatus.

### Description of Related Art

Zoom lenses for image pickup apparatuses such as television cameras, movie cameras, digital still cameras, video cameras, and surveillance cameras are required to be compact and have high optical performance. In addition, along with high definition such as 4K and 8K, they are also required to have high resolving power from the center to the periphery of the angle of view.

Each of Japanese Patent Laid-Open Nos. 2020-160263 and 2016-080877 discloses a zoom lens that includes, in order from an object side to an image side, a first lens unit fixed during zooming and having a positive refractive power, three lens units movable during zooming, and a final lens unit fixed during zooming and having positive refractive power. In these zoom lenses, at least part of the first lens unit moves during focusing.

In such a zoom lens, focus sensitivity as a moving amount of an image plane relative to a moving amount of a lens unit or sub-lens unit (focusing unit) during focusing is smaller on the wide-angle side than on the telephoto side. The moving amount of the focusing unit necessary for focusing is larger on the wide-angle side than on the telephoto side relative to the same focus shift amount. Thus, if a focus shift occurs due to an environmental change such as a temperature change, it may become difficult to focus on a wide-angle side. Accordingly, in order to reduce a focus shift caused by temperature changes, a positive lens included in a lens unit closest to the image plane or the final (rearmost) lens unit among the lens units that move during zooming uses a material having a large positive temperature coefficient of refractive index. However, in the zoom lenses disclosed in Japanese Patent Laid-Open Nos. 2020-160263 and 2016-080877, the temperature coefficient of the refractive index of the positive lens is small, so a focus shift amount caused by temperature changes increases.

### SUMMARY

A zoom lens according to one aspect of the embodiment in which a distance between adjacent lens units changes during zooming includes in order from an object side to an image side a first lens unit fixed during zooming and having positive refractive power, three or more moving lens units movable during zooming, and a final lens unit fixed during zooming and having positive refractive power. At least part of the first lens unit moves during focusing. At least one of a moving lens unit closest to an image plane among the three or more moving lens units and the final lens unit includes a first lens having positive refractive power. The following inequalities are satisfied:

1.60≤ngp≤1.73

4.1×10⁻⁶≤dndTp≤12.0×10⁻⁶

1.90≤ngp+0.0046×vgp

0.3≤dr/fr≤1.5

where ngp is a refractive index of the first lens for d-line, vgp is an Abbe number of the first lens based on the d-line, dndTp is a temperature coefficient of the refractive index of the first lens for the d-line from 20° C. to 40° C., dr is a distance on an optical axis from a lens surface closest to an object to a lens surface closest to the image plane in the final lens unit, and fr is a focal length of the final lens unit. An image pickup apparatus having the above zoom lens also constitutes another aspect of the embodiment.

Further features of the disclosure will become apparent from the following description of embodiments with reference to the attached drawings.

### BRIEF DESCRIPTION OF THE DRAWINGS

FIG. 1 is a sectional view of a zoom lens according to Example 1 (numerical example 1).

FIGS. 2A, 2B, and 2C are aberration diagrams of the zoom lens according to numerical example 1 at a wide-angle end, intermediate zoom position (middle position), and telephoto end.

FIG. 3 is a sectional view of a zoom lens according to Example 2 (numerical example 2).

FIGS. 4A, 4B, and 4C are aberration diagrams of the zoom lens according to numerical example 2 at a wide-angle end, intermediate zoom position, and telephoto end.

FIG. 5 is a sectional view of a zoom lens according to Example 3 (numerical example 3).

FIGS. 6A, 6B, and 6C are aberration diagrams of the zoom lens according to numerical example 3 at a wide-angle end, intermediate zoom position, and telephoto end.

FIG. 7 is a sectional view of a zoom lens according to Example 4 (numerical example 4).

FIGS. 8A, 8B, and 8C are aberration diagrams of the zoom lens according to numerical example 4 at a wide-angle end, intermediate zoom position, and telephoto end.

FIG. 9 is a sectional view of a zoom lens according to Example 5 (numerical example 5).

FIGS. 10A, 10B, and 10C are aberration diagrams of the zoom lens according to numerical example 5 at a wide-angle end, intermediate zoom position, and telephoto end.

FIG. 11 is a sectional view of a zoom lens according to Example 6 (numerical example 6).

FIGS. 12A, 12B, and 12C are aberration diagrams of the zoom lens according to numerical example 6 at a wide-angle end, intermediate zoom position, and telephoto end.

FIG. 13 is a sectional view of a zoom lens according to Example 7 (numerical example 7).

FIGS. 14A, 14B, and 14C are aberration diagrams of the zoom lens according to numerical example 7 at a wide-angle end, intermediate zoom position, and telephoto end.

FIG. 15 illustrates an image pickup apparatus having a zoom lens according to any one of Examples 1 to 7.

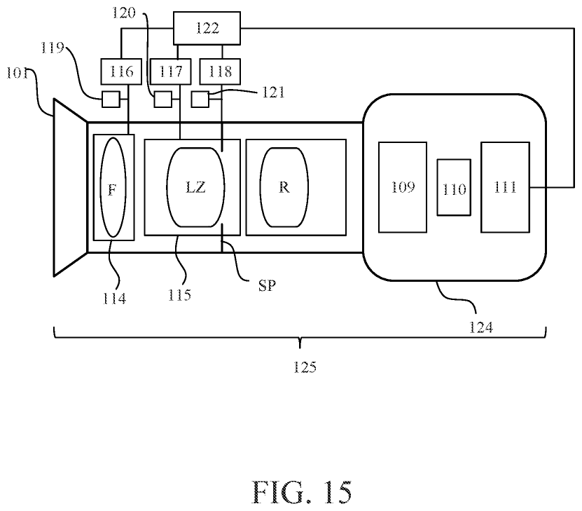

### DESCRIPTION OF THE EMBODIMENTS

Referring now to the accompanying drawings, a detailed description will be given of embodiments according to the disclosure.

A description will now be given of matters common to zoom lenses according to Examples 1 to 7. In the zoom lens according to each example, the lens unit is a group of one or more lenses that move or is fixed together during zooming (magnification variation) between a wide-angle end and a telephoto end. That is, a distance between adjacent lens units changes during zooming. The lens unit may include an aperture stop (diaphragm). The wide-angle end and the telephoto end mean a maximum angle of view (shortest focal length) and a minimum angle of view (longest focal length) in a case where the lens unit that moves during zooming is located at both ends of a mechanically or controllably movable range on the optical axis.

The zoom lens according to each example is to suppress focus shift caused by temperature changes and to have high optical performance over the entire zoom range, small size, and light weight. Thus, conditions of positive lenses included in lens units on the image side, which have high focus sensitivity on the wide-angle side, and a ratio of a focal length to the overall thickness of the final lens unit are properly set. More specifically, the zoom lens according to each example has a zoom ratio of about 2.0 to 3.5 times, is small and lightweight, has high optical performance, and suppresses focus shift caused by temperature changes.

The zoom lens according to each example includes, in order from the object side to the image side, a first lens unit having positive refractive power and fixed during zooming, three or more moving lens units that move during zooming, and a final lens unit fixed during zooming and having positive refractive power. At least part of the first lens unit moves during focusing. The final lens unit includes a Gp lens (first lens) having positive refractive power. The Gp lens may be included in at least one of the moving lens unit closest to the image plane among the three or more moving lens units and the final lens unit.

The zoom lens according to each example satisfies the following inequalities (1) to (4):

1.60≤ngp≤1.73 (1)

4.1×10⁻⁶≤dndTp≤12.0×10⁻⁶ (2)

1.90≤ngp+0.0046×vgp (3)

0.3≤dr/fr≤1.5 (4)

where ngp is a refractive index of the Gp lens for the d-line (wavelength 587.6 nm), vgp is an Abbe number of the Gp lens based on the d-line, and dndT is a temperature coefficient of the refractive index of the Gp lens for the d-line from 20° C. to 40° C., dr is a distance on the optical axis from the lens surface closest to the object to the lens surface closest to the image plane in the final lens unit, and fr is a focal length of the final lens unit.

Inequality (1) relates to a proper refractive index of the Gp lens material. In a case where ngp is lower than a lower limit of inequality (1), the refractive index of the Gp lens becomes too small, the absolute value of the curvature of the lens surface increases, and it becomes difficult to suppress various aberrations. If the absolute value of the curvature increases, the thickness of the Gp lens on the optical axis increases, and miniaturization becomes difficult. In a case where ngp becomes higher than the upper limit of inequality (1), the refractive index of the Gp lens becomes too large and the curvature of field increases.

Inequality (2) relates to a proper temperature coefficient of the refractive index of the Gp lens material. In a case where dndTp becomes lower than the lower limit of inequality (2), a focus shift amount caused by temperature changes increases and focusing becomes difficult on the wide-angle side. In a case where dndTp becomes higher than the upper limit of inequality (2), the Abbe number becomes too small and it becomes difficult to correct chromatic aberration.

Inequality (3) indicates a proper relationship between the refractive index of the Gp lens and the Abbe number. In a case where the value of inequality (3) becomes lower than the lower limit, the refractive index becomes too small relative to the Abbe number, the absolute value of the curvature of the lens surface becomes large, and aberration correction becomes difficult. In a case where the absolute value of the curvature increases, the thickness of the Gp lens on the optical axis increases, and miniaturization becomes difficult.

Inequality (4) indicates a proper relationship between the thickness of the final lens unit on the optical axis and the focal length of the final lens unit. In a case where dr/fr becomes lower than the lower limit of inequality (4), the thickness of the final lens unit becomes small relative to the focal length of the final lens unit, which is beneficial to miniaturization, but the refractive powers of lenses in the final lens unit increase, which is disadvantageous for correcting aberrations. In a case where dr/fr becomes higher than the upper limit of inequality (4), the thickness of the final lens unit becomes large relative to the focal length of the final lens unit, which is disadvantageous for miniaturization.

Inequalities (1) to (4) may be replaced with inequalities (1a) to (4a) below:

1.62≤ngp≤1.72 (1a)

4.2×10⁻⁶≤dndTp≤10.0×10⁻⁶ (2a)

1.90≤ngp+0.0046×vgp≤1.97 (3a)

0.4≤dr/fr≤1.3 (4a)

Inequalities (1) to (4) may be replaced with inequalities (1b) to (4b) below:

1.64≤ngp≤1.71 (1b)

4.3×10⁻⁶≤dndTp≤8.0×10⁻⁶ (2b)

1.90≤ngp+0.0046×vgp≤1.95 (3b)

0.5≤dr/fr≤1.1 (4b)

The zoom lens according to each example that satisfies the above conditions has high optical performance over the entire zoom range and suppresses a focus shift caused by temperature changes by properly selecting the material of the positive lens included in the moving lens unit closest to the image plane or the final lens unit, and by properly setting a proper relationship between the thickness and focal length of the final lens unit.

The zoom lens according to each example may satisfy at least one of the following inequalities (5) to (7).

The final lens unit includes a UD lens (second lens) having positive refractive power, where νud is an Abbe number of the UD lens based on the d-line, and Fgθud is a partial dispersion ratio for the g-line and the F-line of the UD lens. In this case, the following conditions of inequalities (5) and (6) may be met.

62≤νud (5)

0.640≤θgFud+0.001625×νud≤0.700 (6)

In a case where νud becomes lower than the lower limit of inequality (5), the temperature coefficient of the refractive index of the UD lens material does not become negative, so focus shift caused by temperature changes can be suppressed, but correction of chromatic aberration becomes difficult.

In a case where the value of inequality (6) becomes lower than the lower limit, the partial dispersion ratio of the material of the UD lens is small, and it becomes difficult to correct chromatic aberration. In a case where the value of inequality (6) becomes higher than the upper limit, the partial dispersion ratio of the material of the UD lens becomes too large, and chromatic aberration is overcorrected.

Inequalities (5) and (6) may be replaced with inequalities (5a) and (6a) below:

63≤νud (5a)

0.644≤θgFud+0.001625×νud≤0.695 (6a)

Inequalities (5) and (6) may be replaced with inequalities (5b) and (6b) below:

65≤νud (5b)

0.650≤θgFud+0.001625×νud≤0.690 (6b)

In the zoom lens according to each example, the Gp lens may be disposed in the final lens unit. In a zoom lens that performs focusing by moving part of the first lens unit, the final lens unit has the highest focus sensitivity on the wide-angle side. Therefore, the Gp lens having positive refractive power and the effect of suppressing focus shift caused by temperature changes in the final lens unit can effectively suppress focus shift caused by temperature changes.

In the zoom lens according to each example, the Gp lens may be disposed closer to the image side than the UD lens. The material of the Gp lens has a large temperature coefficient of refractive index on the positive side, which is beneficial to suppressing focus shift caused by temperature changes, but this material is disadvantageous for correcting chromatic aberration due to its relatively small partial dispersion ratio. Conversely, the temperature coefficient of the refractive index of the UD lens material is large on the negative side, which causes an increase in focus shift caused by temperature changes, but it is beneficial to correct chromatic aberration because the partial dispersion ratio is relatively large. Therefore, by placing the UD lens on the object side where the height of the axial ray in the final lens unit is higher than that of the Gp lens, and by placing the Gp lens on the image side where the height of the axial ray becomes lower, the focus shift caused by the temperature changes can be effectively suppressed and chromatic aberration can be satisfactorily corrected.

The zoom lens according to each example may include an aperture stop and satisfy the following inequality (7):

1.0≤fr/Dopen≤2.4 (7)

where Dopen is an aperture diameter in the aperture stop in its open state.

Inequality (7) indicates a proper relationship between the focal length of the final lens unit and the fully open diameter of the aperture stop. The smaller the value of fr/Dopen becomes, the larger the aperture diameter of the zoom lens (the smaller the F-number) becomes. In a case where fr/Dopen becomes higher than the upper limit of inequality (7), the F-number of the zoom lens increases, which means that the height of the on-axis ray passing through the final lens unit becomes relatively low and thus the advantage of using the UD lens and Gp lens reduces. In a case where fr/Dopen becomes lower than the lower limit of inequality (7), it means that the focal length of the final lens unit becomes small relative to the aperture diameter of the aperture stop. This is beneficial to miniaturization but aberration correction becomes difficult because the refractive power of the final lens unit becomes too large.

Inequality (7) may be replaced with inequality (7a) below:

1.2≤fr/Dopen≤2.3 (7a)

Inequality (7) may be replaced with inequality (7b) below:

1.4≤fr/Dopen≤2.2 (7b)

In the zoom lens according to each example, the aperture stop may move during zooming. For example, by placing the aperture stop closer to the object side at the wide-angle end, the entrance pupil is positioned on the object side, and the height of the off-axis ray passing through the first lens unit is lowered to reduce the lens diameter of the first lens unit, which is beneficial to miniaturization of the first lens unit. Alternatively, an angle can be wider without increasing the lens diameter of the first lens unit.

In the zoom lens according to each example, the movable lens unit may include three or four lens units. Using three or four moving lens units can achieve high optical performance over the entire zoom range. Not increasing the number of moving lens units to five or more can avoid an increase in manufacturing difficulty due to an increase in the number of mechanisms for moving the moving lens units.

In the zoom lens according to each example, the first lens unit may include five or more lenses. The first lens unit with five or more lenses can easily suppress aberration fluctuation during focusing and breathing, which is important in a zoom lens for capturing moving images.

In the zoom lens according to each example, the final lens unit may include three or more lenses. The final lens unit with three or more lenses can secure the necessary number of lenses to achieve high optical performance over the entire zoom range and suppress focus shift caused by temperature changes.

In the zoom lens according to each example, the final lens unit may include ten or less lenses. The size of the zoom lens can be reduced by the final lens unit with ten or less lenses.

The zoom lens according to each example, the final lens unit may include a single (only one) UD lens. UD lenses have a relatively large partial dispersion ratio, which is beneficial for correcting chromatic aberration. However, the temperature coefficient of the refractive index of the lens material is large on the negative side, using multiple UD lenses can increase focus shift caused by temperature changes. Therefore, the single UD lens included in the final lens unit can correct chromatic aberration and suppress focus shift caused by temperature changes.

The zoom lens according to each example may satisfy inequality (8):

1.0≤fl/fw≤10.0 (8)

where fl is a focal length of the first lens unit, and fw is a focal length of the zoom lens at the wide-angle end.

Inequality (8) indicates a proper range for the ratio of the focal length of the first lens unit to the focal length of the zoom lens at the wide-angle end. Satisfying inequality (8) can achieve small size, light weight, and high optical performance. In a case where fl/fw becomes higher than the upper limit of inequality (8), the focal length of the first lens unit becomes excessively long, the lens diameter of the first lens unit becomes large, and it becomes difficult to reduce the size and weight. In a case where fl/fw becomes lower than the lower limit of inequality (8), the focal length of the first lens unit becomes too short, aberration correction becomes difficult, or the focal length at the wide-angle end becomes too long, and it becomes difficult to obtain a zoom lens having a wide angle of view.

Inequality (8) may be replaced with inequality (8a) below:

1.5≤fl/fw≤7.0 (8a)

Inequality (8) may be replaced with inequality (8b) below:

2.0≤fl/fw≤5.0 (8b)

The zoom lens according to each example may satisfy inequality (9):

0.3≤ft/fl≤1.2 (9)

where fl is a focal length of the first lens unit, and ft is a focal length of the zoom lens at the telephoto end.

Inequality (9) indicates a proper range for the ratio of the focal length of the first lens unit to the focal length of the zoom lens at the telephoto end. Satisfying inequality (9) can provides a zoom lens with a high zoom ratio, small size, light weight, and high optical performance. Larger ft/fl is beneficial to obtain a telephoto (high zoom ratio) zoom lens, but it becomes difficult to correct aberration within a permissible range because the aberration is enlarged at the telephoto end, which is caused by the first lens unit U1. In a case where ft/fl becomes higher than the upper limit of inequality (9), the focal length of the first lens unit U1 becomes excessively short, and it becomes difficult to keep the aberration caused by the first lens unit L1 at the telephoto end within the permissible range. The number of lenses becomes excessively large, which is disadvantageous in obtaining a compact and lightweight zoom lens. In a case where ft/fl becomes lower than the lower limit of inequality (9), the focal length of the first lens unit U1 becomes excessively long, and it becomes difficult to obtain a telephoto (high zoom ratio) zoom lens. The moving amount of the moving lens unit becomes excessively large, which is disadvantageous in obtaining a compact and lightweight zoom lens.

Inequality (9) may be replaced with inequality (9a) below:

0.4≤ft/fl≤1.0 (9a)

Inequality (9) may be replaced with inequality (9b) below:

0.5≤ft/fl≤0.9 (9b)

The zoom lens according to each example may satisfy inequality (10) below:

−0.5≤dndTpave≤4.0 (10)

where dndTpave is an average value of temperature coefficients of refractive indexes for the d-line of lenses having positive refractive power included in the final lens unit from 20° C. to 40° C.

Inequality (10) indicates a proper temperature coefficient of the refractive index of the material of the lens having positive refractive power in the final lens unit. In a case where dndTpave becomes higher than the upper limit of inequality (10), it is beneficial in terms of correction of the focus shift amount caused by temperature changes, but many materials with relatively small Abbe numbers are to be used, and it becomes difficult to correct chromatic aberration. In a case where dndTpave becomes lower than the lower limit of inequality (10), the focus shift amount caused by temperature changes increases, and focusing becomes difficult on the wide-angle side.

Inequality (10) may be replaced with inequality (10a):

0.0≤dndTpave≤3.0 (10a)

Inequality (10) may be replaced with inequality (10b):

0.5≤dndTpave≤2.5 (10b)

The specific configurations of the zoom lenses according to Examples 1 to 7 will be described below together with numerical examples 1 to 7 corresponding to Examples 1 to 7, respectively.

### Example 1

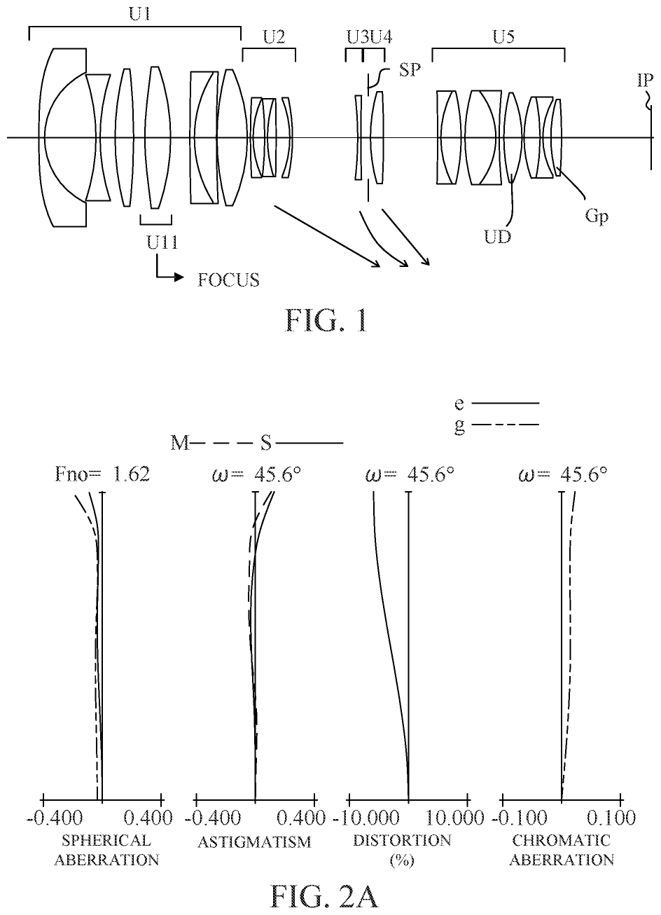

FIG. 1 illustrates a section of a zoom lens according to Example 1 (numerical example 1) at a wide-angle end and in an in-focus state on an infinity object. The zoom lens according to this example includes, in order from the object side to the image side, a first lens unit U1 having positive refractive power, a second lens unit U2 having negative refractive power, a third lens unit U3 having negative refractive power, a fourth lens unit U4 having positive refractive power, and a fifth lens unit U5 as a final (rearmost) lens unit having positive refractive power.

The first lens unit U1 is fixed during zooming, and part of the lenses in the lens unit (sub-lens unit U11) moves toward the image side during focusing from an object at infinity (infinity object) to a close object. The second lens unit U2 and the third lens unit U3 monotonously move toward the image side so as to draw different trajectories (loci) during zooming from the wide-angle end to the telephoto end. The fourth lens unit U4 moves toward the image side in conjunction with the movement of the second lens unit U2 and the third lens unit U3 during zooming from the wide-angle end to the telephoto end, and corrects image plane fluctuations associated with zooming. The second lens unit U2, the third lens unit U3, and the fourth lens unit U4 are movable lens units that move during zooming. The fifth lens unit U5 is fixed during zooming.

In FIG. 1, below the lens units that move during zooming, each arrow indicates a moving locus of each lens unit during zooming from the wide-angle end to the telephoto end. Below the sub-lens unit that moves during focusing, an arrow indicates a moving direction of the sub-lens unit during focusing from an infinity object to a close object. This is the same for the drawings of other examples to be described below.

In this example and other examples described below, SP denotes an aperture stop. IP denotes an image plane. An imaging plane of a solid-state image sensor (photoelectric conversion element) that receives (images) an optical image formed by the zoom lens in the image pickup apparatus or a film plane (photosensitive surface) of a silver film is disposed on the image plane IP. The aperture stop SP is disposed closest to the object in the fourth lens unit U4.

In this numerical example and other numerical examples to be described below, a surface number i represents the order of surfaces counted from the object side, r represents a radius of curvature of an i-th surface from the object side, and d represents a lens thickness or the air gap (mm) on the optical axis between i-th and (i+1)-th surfaces. nd and νd respectively represent a refractive index of a medium (optical material) between the i-th and (i+1)-th surfaces for the d-line and the Abbe number based on the d-line. BF represents back focus (mm). The “back focus” is a distance on the optical axis from the final surface (lens surface closest to the image plane) of the zoom lens to a paraxial image plane expressed in terms of air length. The “overall lens length” is a length obtained by adding the back focus to a distance on the optical axis from the foremost lens surface (lens surface closest to the object) to the final lens surface of the zoom lens.

An asterisk “*” attached to a surface number means that the surface has an aspherical shape. The aspherical shape is expressed as follows:

$$X = \frac{{H}^{2} / R}{1 + \sqrt{1 - ( 1 + K ) {( H / R )}^{2}}} + A 4 \cdot {H}^{4} + A 6 \cdot {H}^{6} + A 8 \cdot {H}^{8} + A 10 \cdot {H}^{10} + A 12 \cdot {H}^{12} + A 14 \cdot {H}^{14} + A 16 \cdot {H}^{16} + A 18 \cdot {H}^{18} + A 20 \cdot {H}^{20}$$

where X is a displacement amount from a surface vertex in the optical axis direction, H is a height from the optical axis in a direction orthogonal to the optical axis, a light traveling direction is set positive, R is a paraxial radius of curvature, K is a conic constant, A4 to A20 are aspherical coefficients of respective orders. “e±Z” in the conic constant means “×10^{±Z}.”

In this example (numerical example), the first lens unit U1 has 1st to 13th surfaces, and the second lens unit U2 has 14th to 20th surfaces. The third lens unit U3 has 21st to 22nd surfaces, and the fourth lens unit U4 has a 23rd surface of the aperture stop SP to a 25th surface. The fifth lens unit U5 has 26th to 38th surfaces. The Gp lens is a 21st lens (37th surface) from the object side, and the UD lens is the 18th lens (32th surface) from the object side. Tables 1 and 2 summarize the properties of the respective materials of the Gp lens and the UD lens in this numerical example.

Table 3 summarizes values corresponding to inequalities (1) to (10) in this numerical example. This numerical example satisfies all inequalities (1) to (10).

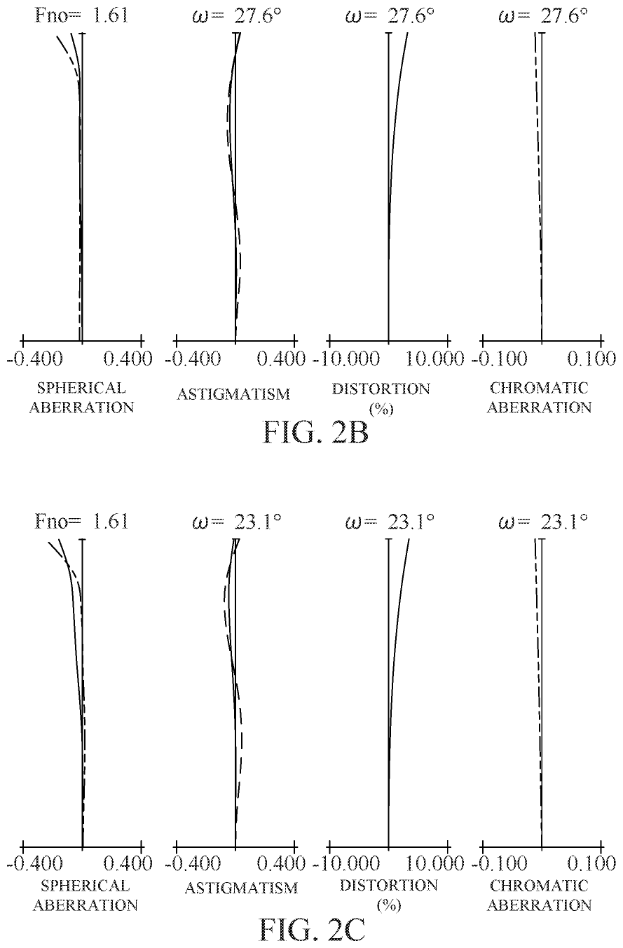

FIGS. 2A, 2B, and 2C illustrate longitudinal aberrations (spherical aberration, astigmatism, distortion, and chromatic aberration) of the zoom lens according to this numerical example in an in-focus state on an infinity object. FIG. 2A illustrates longitudinal aberration at the wide-angle end, FIG. 2B illustrates longitudinal aberration at the intermediate zoom position (middle zoom position) (focal length of 28.3 mm), and FIG. 2C illustrates longitudinal aberration at the telephoto end. In the spherical aberration diagram, Fno represents an F-number, a solid line represents a spherical aberration amount for the e-line (wavelength 546.1 nm), and an alternate long and two short dashes line represents a spherical aberration amount for the g-line (wavelength 435.8 nm). In the astigmatism diagram, a solid line S indicates a sagittal image plane, and a dashed line M indicates a meridional image plane. The distortion diagram illustrates a distortion amount for the e-line. The chromatic aberration diagram illustrates a lateral chromatic aberration amount for the g-line. ω represents a half angle of view (°). The scales are 0.4 mm for spherical aberration, 0.4 mm for astigmatism, 10% for distortion, and 0.1 mm for lateral chromatic aberration. The wide-angle end and the telephoto end indicate zoom positions in a case where the second lens unit U2 is located at both ends of a range in which it can be moved on the optical axis by its moving mechanism. These aberration diagrams (except for the focal length at the intermediate zoom position) are the same for other numerical examples to be described below.

### Example 2

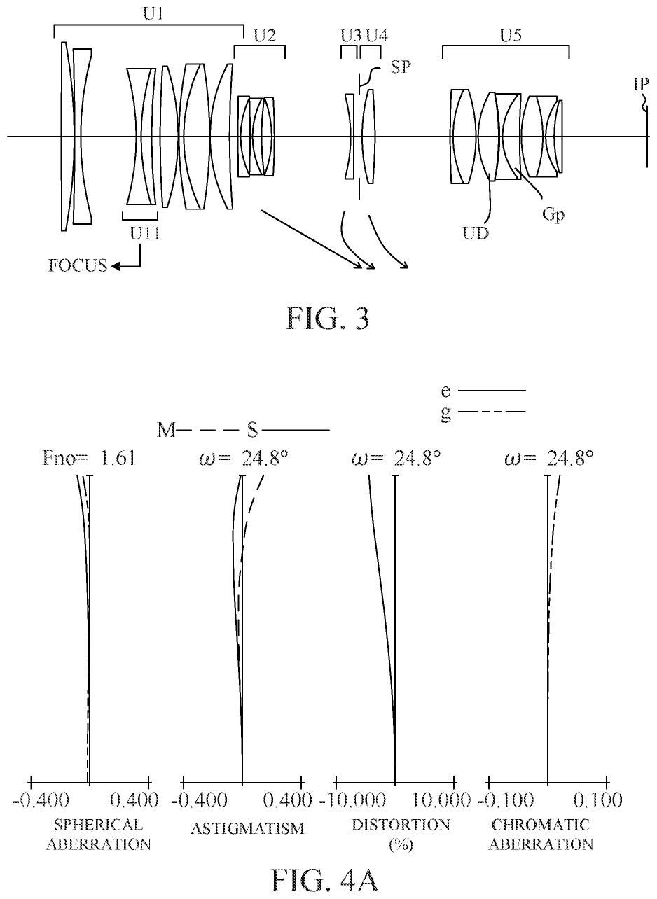

FIG. 3 illustrates a section of a zoom lens according to Example 2 (numerical example 2) at a wide-angle end and in an in-focus state on an infinity object. The zoom lens according to this example includes, in order from the object side to the image side, a first lens unit U1 having positive refractive power, a second lens unit U2 having negative refractive power, a third lens unit U3 having negative refractive power, a fourth lens unit U4 having positive refractive power, and a fifth lens unit U5 as a final lens unit having positive refractive power.

The first lens unit U1 is fixed during zooming, and part of the lenses in the lens unit (sub-lens unit U11) moves to the object side during focusing from an infinity object to a close object. The second lens unit U2 and the third lens unit U3 move along different trajectories (loci) during zooming from the wide-angle end to the telephoto end. At this time, the second lens unit U2 monotonously moves toward the image side, and the third lens unit U3 moves toward the image side after once moving toward the object side. The fourth lens unit U4 moves toward the image side in conjunction with the movements of the second lens unit U2 and the third lens unit U3 during zooming from the wide-angle end to the telephoto end, and corrects image plane fluctuations associated with zooming. The second lens unit U2, the third lens unit U3, and the fourth lens unit U4 are movable lens units that move during zooming. The fifth lens unit U5 is fixed during zooming. The aperture stop SP is disposed closest to the object in the fourth lens unit U4.

In this example (numerical example), the first lens unit U1 has 1st to 14th surfaces, and the second lens unit U2 has 15th to 21st surfaces. The third lens unit U3 has 22nd to 23rd surfaces, and the fourth lens unit U4 has a 24th surface of the aperture stop SP to a 26th surface. The fifth lens unit U5 has 27th to 39th surfaces. The Gp lens is a 19th lens (33rd surface) from the object side, and the UD lens is a 17th lens (30th surface) from the object side. Tables 1 and 2 illustrate the properties of the respective materials of the Gp lens and the UD lens in this numerical example.

Table 3 summarizes values corresponding to inequalities (1) to (10) in this numerical example. This numerical example satisfies all inequalities (1) to (10).

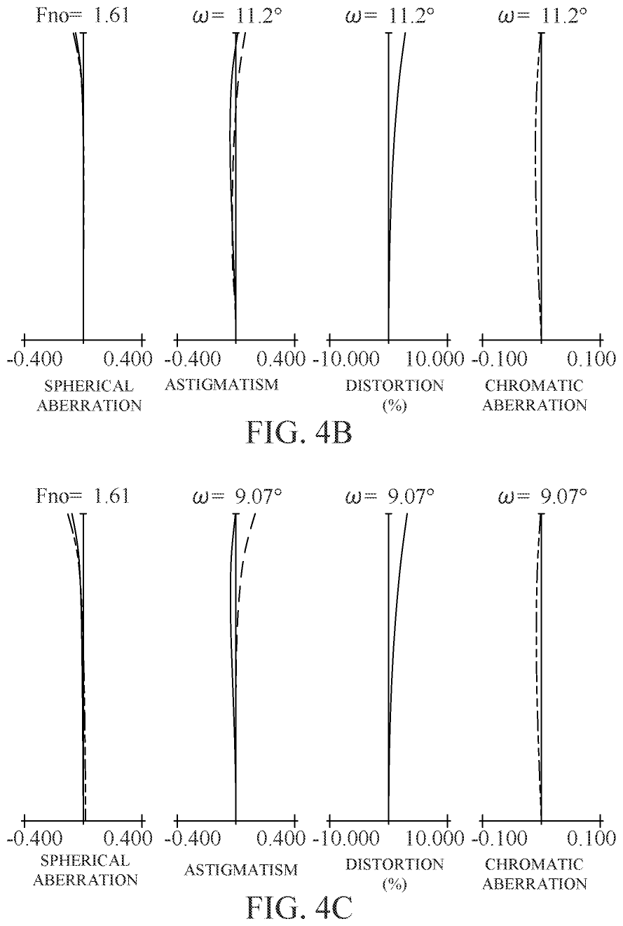

FIGS. 4A, 4B, and 4C illustrate the longitudinal aberration of the zoom lens according to this numerical example in an in-focus state on an infinity object. FIG. 4A illustrates longitudinal aberration at the wide-angle end, FIG. 4B illustrates longitudinal aberration at the intermediate zoom position (focal length of 75.0 mm), and FIG. 4C illustrates longitudinal aberration at the telephoto end.

### Example 3

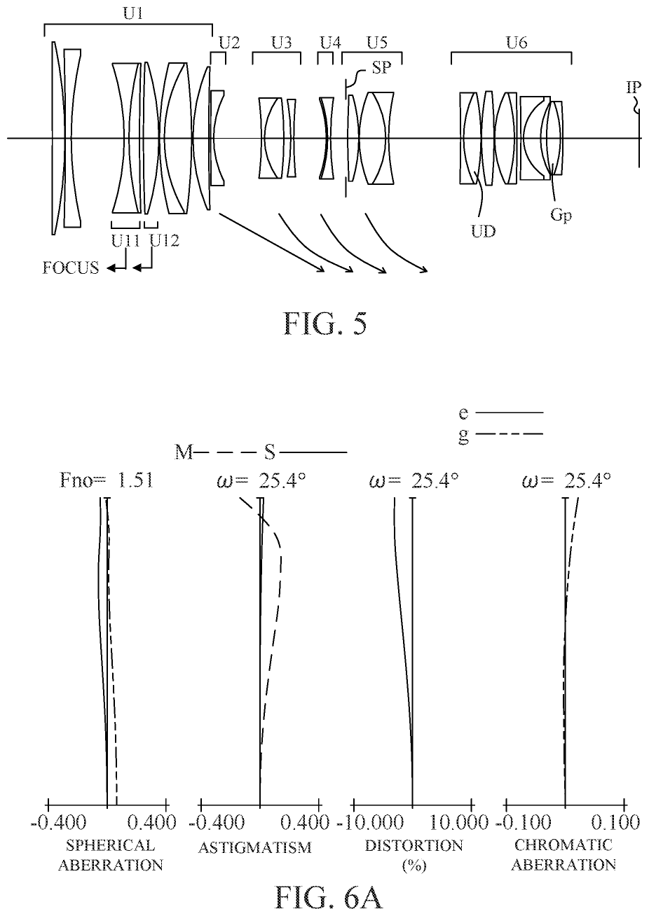

FIG. 5 illustrates a section of a zoom lens according to Example 3 (numerical example 3) at a wide-angle end and in an in-focus state on an infinity object. The zoom lens according to this example includes, in order from the object side to the image side, a first lens unit U1 having positive refractive power, a second lens unit U2 having negative refractive power, a third lens unit U3 having negative refractive power, a fourth lens unit U4 having negative refractive power, a fifth lens unit U5 having positive refractive power, and a sixth lens unit U6 as a final lens unit having positive refractive power.

The first lens unit U1 is fixed during zooming, and part of the lenses in the lens unit (sub-lens units U11 and U12) moves toward the object side during focusing from an infinity object to a close object. The second lens unit U2, the third lens unit U3, and the fourth lens unit U4 monotonously move toward the image side so as to draw different trajectories during zooming from the wide-angle end to the telephoto end. During zooming from the wide-angle end to the telephoto end, the fifth lens unit U5 moves toward the image side in conjunction with the movements of the second lens unit U2, the third lens unit U3, and the fourth lens unit U4, and corrects image plane fluctuations associated with zooming. The second lens unit U2, the third lens unit U3, the fourth lens unit U4, and the fifth lens unit U5 are movable lens units that move during zooming. The sixth lens unit U6 is fixed during zooming. The aperture stop SP is disposed closest to the object in the fifth lens unit U5.

In this example (numerical example), the first lens unit U1 has 1st to 14th surfaces, and the second lens unit U2 has 15th to 16th surfaces. The third lens unit U3 has 17th to 21st surfaces, and the fourth lens unit U4 has 22nd to 24th surfaces. The fifth lens unit U5 has a 25th surface of the aperture stop SP to a 30th surface, and the sixth lens unit U6 has 31st to 44th surfaces. The Gp lens is a 25th lens (42th surface) from the object side, and the UD lens is a 19th lens (32 surface) from the object side. Tables 1 and 2 illustrate the properties of the respective materials of the Gp lens and the UD lens in this numerical example.

Table 3 summarizes values corresponding to inequalities (1) to (10) in this numerical example. This numerical example satisfies all inequalities (1) to (10).

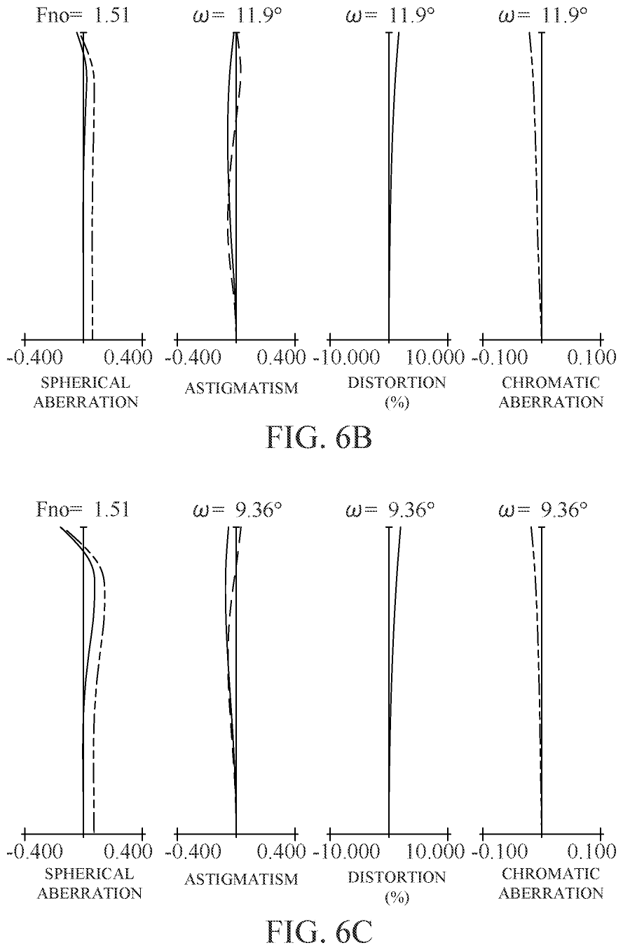

FIGS. 6A, 6B, and 6C illustrate the longitudinal aberration of the zoom lens according to this numerical example in an in-focus state on an infinity object. FIG. 6A illustrates the longitudinal aberration at the wide-angle end, FIG. 6B illustrates the longitudinal aberration at the intermediate zoom position (focal length of 70.0 mm), and FIG. 6C illustrates the longitudinal aberration at the telephoto end.

### Example 4

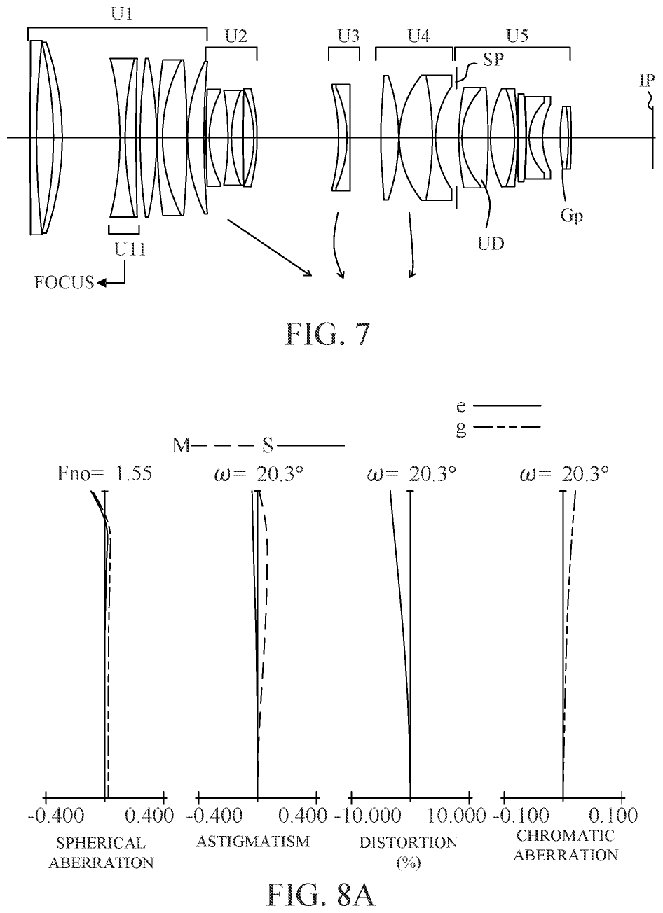

FIG. 7 illustrates a section of a zoom lens according to Example 4 (numerical example 4) at a wide-angle end and in an in-focus state on an infinity object. The zoom lens according to this example includes, in order from the object side to the image side, a first lens unit U1 having positive refractive power, a second lens unit U2 having negative refractive power, a third lens unit U3 having negative refractive power, a fourth lens unit U4 having positive refractive power, and a fifth lens unit U5 as a final lens unit having positive refractive power. The first lens unit U1 is fixed during zooming, and a part of the lenses (sub-lens unit U11) in the lens unit moves toward the object side during focusing from an infinity object to a close object. The second lens unit U2 and the third lens unit U3 move along different trajectories during zooming from the wide-angle end to the telephoto end. At this time, the second lens unit U2 monotonously moves toward the image side, and the third lens unit U3 moves toward the image side after once moving toward the object side. During zooming from the wide-angle end to the telephoto end, the fourth lens unit U4 moves to the image side and the object side in conjunction with the movements of the second lens unit U2 and the third lens unit U3 and corrects image plane fluctuations associated with zooming. The second lens unit U2, the third lens unit U3, and the fourth lens unit U4 are movable lens units that move during zooming. The fifth lens unit U5 is fixed during zooming.

In this example, the aperture stop SP is disposed closest to the object in the fifth lens unit U5.

In this example (numerical example), the first lens unit U1 has 1st to 14th surfaces, and the second lens unit U2 has 15th to 21st surfaces. The third lens unit U3 has 22nd to 24th surfaces, and the fourth lens unit U4 has 25th to 29th surfaces. The fifth lens unit U5 has a 30th surface of the aperture stop SP to a 44th surface. The Gp lens is a 25th lens (42nd surface) from the object side, and the UD lens is a 19th lens (32nd surface) from the object side. The respective material properties of the Gp and UD lenses according to numerical example 4 are illustrated in Tables 1 and 2.

Table 3 summarizes values corresponding to inequalities (1) to (10) in this numerical example. This numerical example satisfies all inequalities (1) to (10).

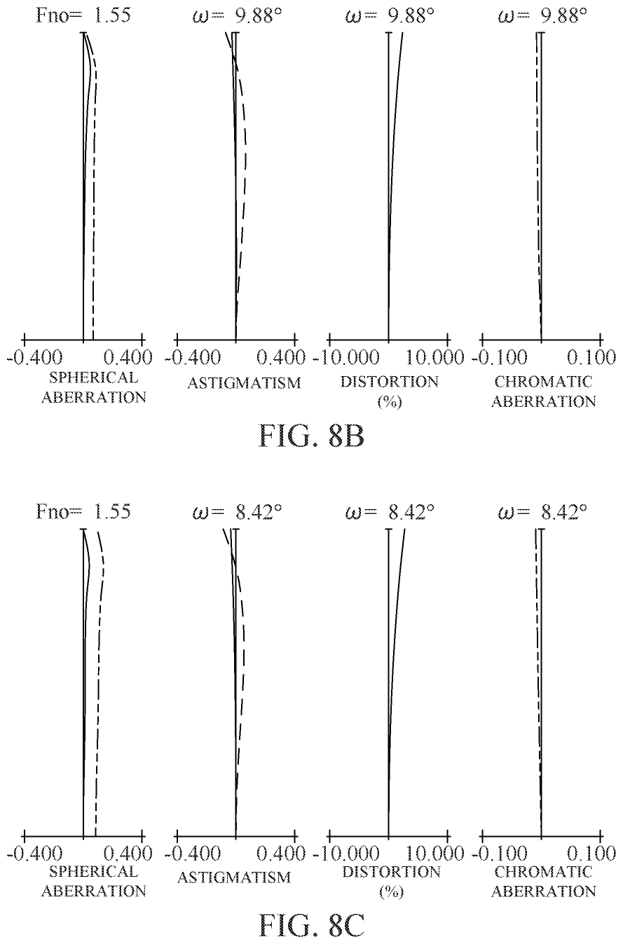

FIGS. 8A, 8B, and 8C illustrate the longitudinal aberration of the zoom lens according to this numerical example in an in-focus state on an infinity object. FIG. 8A illustrates the longitudinal aberration at the wide-angle end, FIG. 8B illustrates the longitudinal aberration at the intermediate zoom position (focal length of 85.0 mm), and FIG. 8C illustrates the longitudinal aberration at the telephoto end.

### Example 5

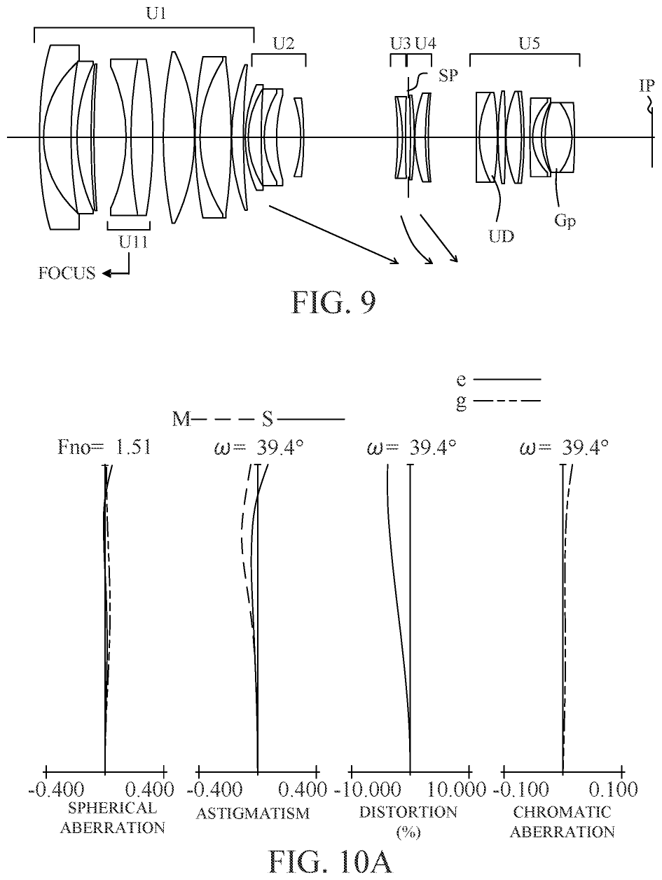

FIG. 9 illustrates a section of a zoom lens according to Example 5 (numerical example 5) at a wide-angle end and in an in-focus stat on an infinity object. The zoom lens according to this example includes, in order from the object side to the image side, a first lens unit U1 having positive refractive power, a second lens unit U2 having negative refractive power, a third lens unit U3 having negative refractive power, a fourth lens unit U4 having positive refractive power, and a fifth lens unit U5 as a final lens unit having positive refractive power.

The first lens unit U1 is fixed during zooming, and a part of the lenses (sub-lens unit U11) in the lens unit moves to the object side during focusing from an infinity object to a close object. The second lens unit U2 and the third lens unit U3 monotonously move toward the image side so as to draw different trajectories during zooming from the wide-angle end to the telephoto end. The fourth lens unit U4 moves toward the image side in conjunction with the movements of the second lens unit U2 and the third lens unit U3 during zooming from the wide-angle end to the telephoto end, and corrects image plane fluctuation associated with zooming. The second lens unit U2, the third lens unit U3, and the fourth lens unit U4 are moving lens units that move during zooming. The fifth lens unit U5 is fixed during zooming. The aperture stop SP is disposed closest to the object in the fourth lens unit U4.

In this example (numerical example), the first lens unit U1 has 1st to 16th surfaces, and the second lens unit U2 has 17th to 23rd surfaces. The third lens unit U3 has 24th to 26th surfaces, and the fourth lens unit U4 has a 27th surface of the aperture stop SP to a 32nd surface. The fifth lens unit U5 has 33rd to 46th surfaces. The Gp lens is a 26th lens (44th surface) from the object side, and the UD lens is a 20th lens (34th surface) from the object side. Tables 1 and 2 illustrate the properties of the respective materials of the Gp lens and the UD lens in this numerical example.

Table 3 summarizes the values corresponding to inequalities (1) to (10) in this numerical example. This numerical example satisfies all inequalities (1) to (10).

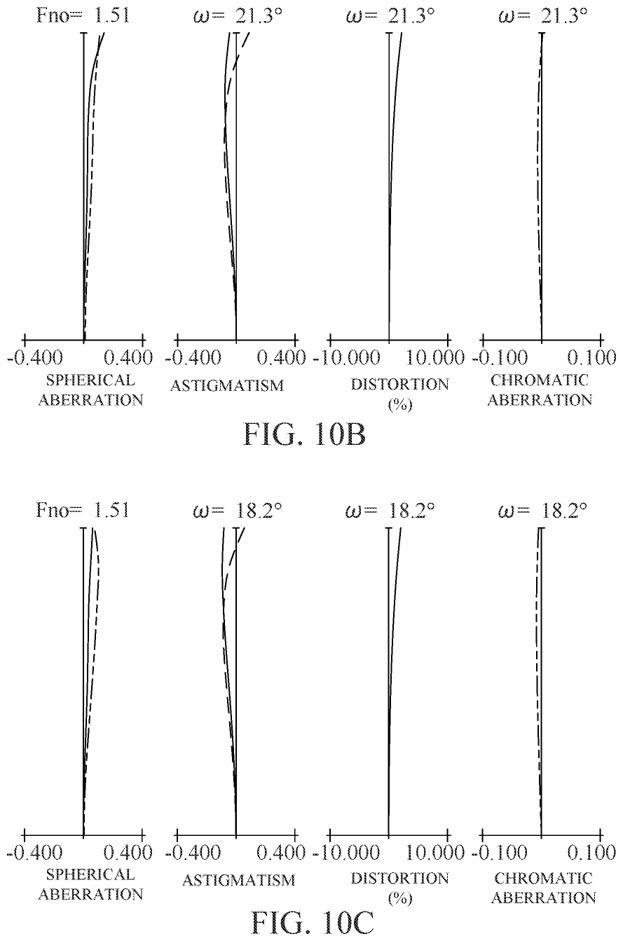

FIGS. 10A, 10B, and 10C illustrate the longitudinal aberration of the zoom lens according to this numerical example in an in-focus state on an infinity object. FIG. 10A illustrates the longitudinal aberration at the wide-angle end, FIG. 10B illustrates the longitudinal aberration at the intermediate zoom position (focal length of 38.0 mm), and FIG. 10C illustrates the longitudinal aberration at the telephoto end.

### Example 6

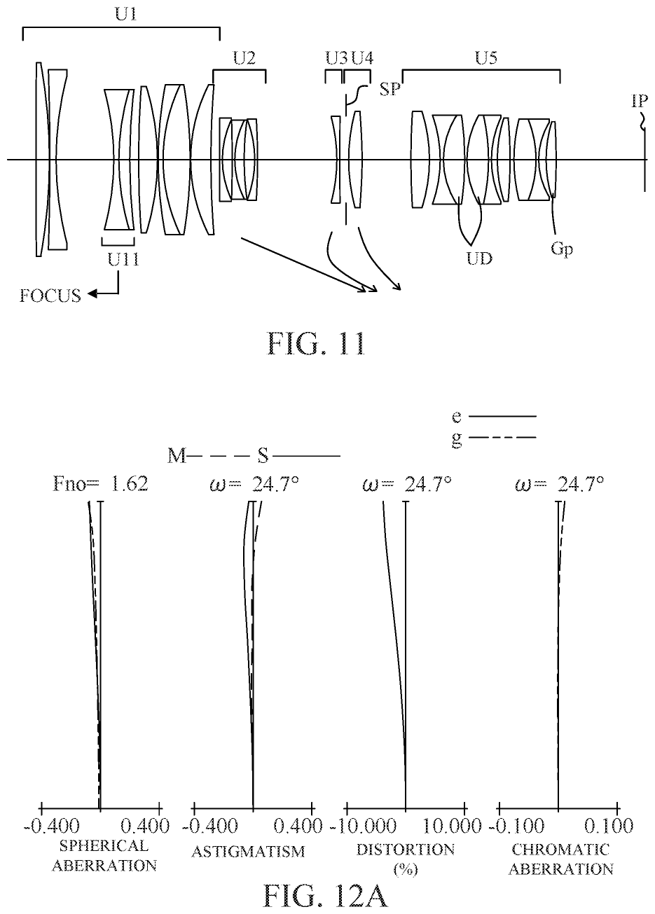

FIG. 11 illustrates a section of a zoom lens according to Example 6 (numerical example 6) at a wide-angle end and in an in-focus state on an infinity object. The zoom lens according to this example includes, in order from the object side to the image side, a first lens unit U1 having positive refractive power, a second lens unit U2 having negative refractive power, a third lens unit U3 having negative refractive power, a fourth lens unit U4 having positive refractive power, and a fifth lens unit U5 as a final lens unit having positive refractive power.

The first lens unit U1 is fixed during zooming, and part of the lenses in the lens unit (sub-lens unit U11) moves to the object side during focusing from an infinity object to a close object. The second lens unit U2 and the third lens unit U3 move along different trajectories during zooming from the wide-angle end to the telephoto end. At this time, the second lens unit U2 monotonously moves toward the image side, and the third lens unit U3 moves toward the image side after once moving toward the object side. The fourth lens unit U4 moves toward the image side in conjunction with the movements of the second lens unit U2 and the third lens unit U3 during zooming from the wide-angle end to the telephoto end, and corrects image plane fluctuation associated with zooming. The second lens unit U2, the third lens unit U3, and the fourth lens unit U4 are moving lens units that move during zooming. The fifth lens unit U5 is fixed during zooming, and an aperture stop SP is disposed closest to the object in the fourth lens unit U4.

In this example (numerical example), the first lens unit U1 has 1st to 14th surfaces, and the second lens unit U2 has 15th to 21st surfaces. The third lens unit U3 has 22nd and 23rd surfaces, and the fourth lens unit U4 has a 24th surface of the aperture stop SP to a 26th surface. The fifth lens unit U5 has 27th to 42nd surfaces. The Gp lens is a 24th lens (41st surface) from the object side, and the UD lenses are a 17th lens (30th surface) and a 18th lens (32nd surface) from the object side. Tables 1 and 2 illustrate the properties of the respective materials of the Gp lens and the UD lens in this numerical example.

Table 3 summarizes values corresponding to inequalities (1) to (10) in this numerical example. This numerical example satisfies all inequalities (1) to (10).

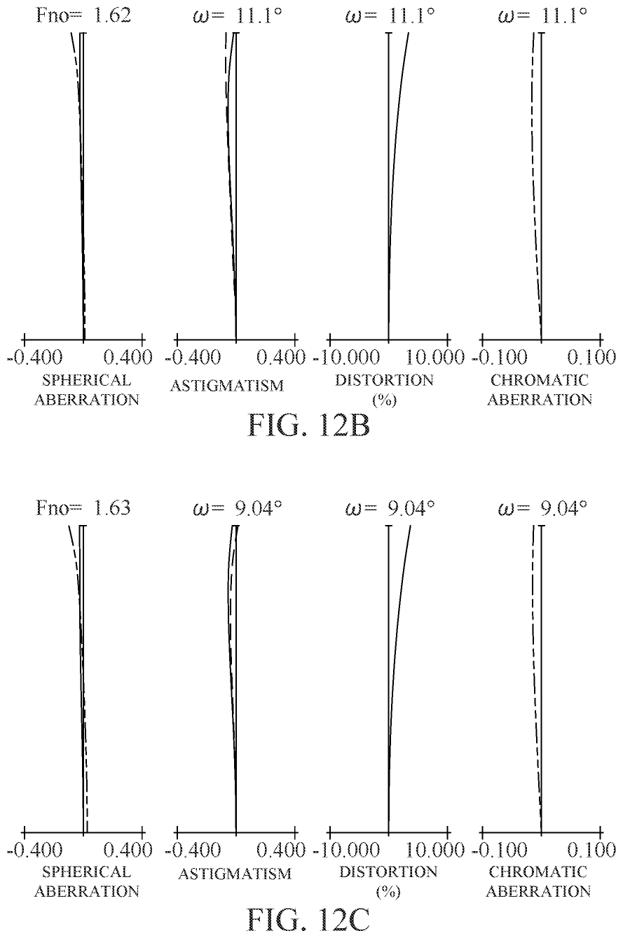

FIGS. 12A, 12B, and 12C illustrate longitudinal aberrations of the zoom lens according to this numerical example in an in-focus state on an infinity object. FIG. 12A illustrates longitudinal aberration at the wide-angle end, FIG. 12B illustrates longitudinal aberration at the intermediate zoom position (focal length of 75.2 mm), and FIG. 12C illustrates longitudinal aberration at the telephoto end.

### Example 7

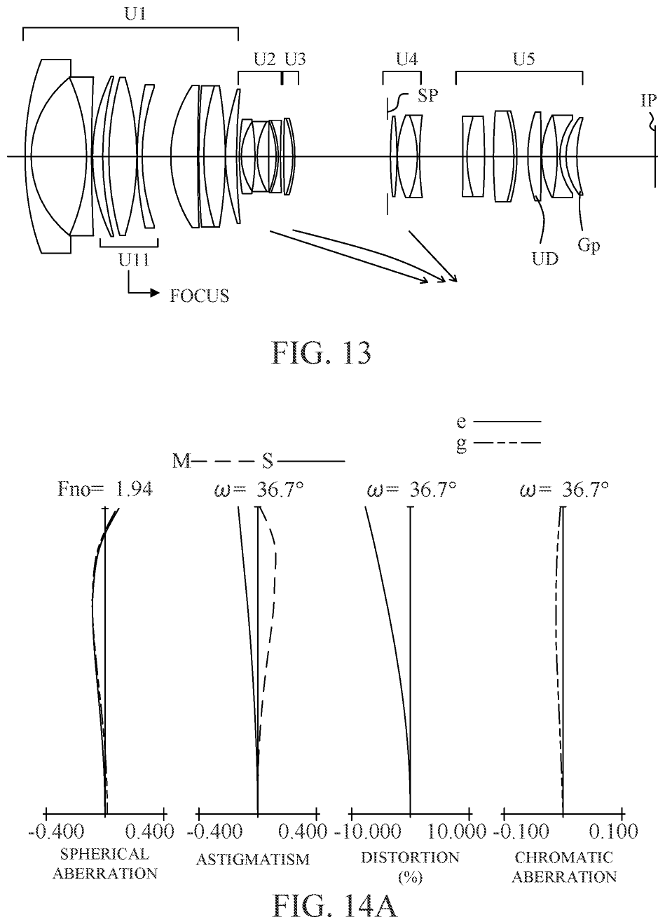

FIG. 13 illustrates a section of a zoom lens according to Example 7 (numerical example 7) at a wide-angle end and in an in-focus on an infinity object. The zoom lens according to this example includes, in order from the object side to the image side, a first lens unit U1 having positive refractive power, a second lens unit U2 having negative refractive power, a third lens unit U3 having positive refractive power, a fourth lens unit U4 having positive refractive power, and a fifth lens unit U5 as a final lens unit having positive refractive power.

The first lens unit U1 is fixed during zooming, and part of the lenses in the lens unit (sub-lens unit U11) moves toward the image side during focusing from an object at infinity to a close object. The second lens unit U2 and the third lens unit U3 monotonously move toward the image side so as to draw different trajectories during zooming from the wide-angle end to the telephoto end. The fourth lens unit U4 moves toward the image side in conjunction with the movement of the second lens unit U2 and the third lens unit U3 during zooming from the wide-angle end to the telephoto end, and corrects image plane fluctuations associated with zooming. The second lens unit U2, the third lens unit U3, and the fourth lens unit U4 are movable lens units that move during zooming. The fifth lens unit U5 is fixed during zooming, and an aperture stop SP is disposed closest to the object in the fourth lens unit U4.

In this example (numerical example), the first lens unit U1 has 1st to 17th surfaces, and the second lens unit U2 has 18th to 25th surfaces. The third lens unit U3 has 26th to 28th surfaces, and the fourth lens unit U4 has a surface 29th of the aperture stop SP to a 34th surface. The fifth lens unit U5 has 35th to 47th surfaces. The Gp lens is a 27th lens (46th surface) from the object side, and the UD lens is a 24th lens (41th surface) from the object side. Tables 1 and 2 illustrate the properties of the respective materials of the Gp lens and the UD lens in this numerical example.

Table 3 summarizes the values corresponding to inequalities (1) to (10) in this numerical example. This numerical example satisfies all inequalities (1) to (10).

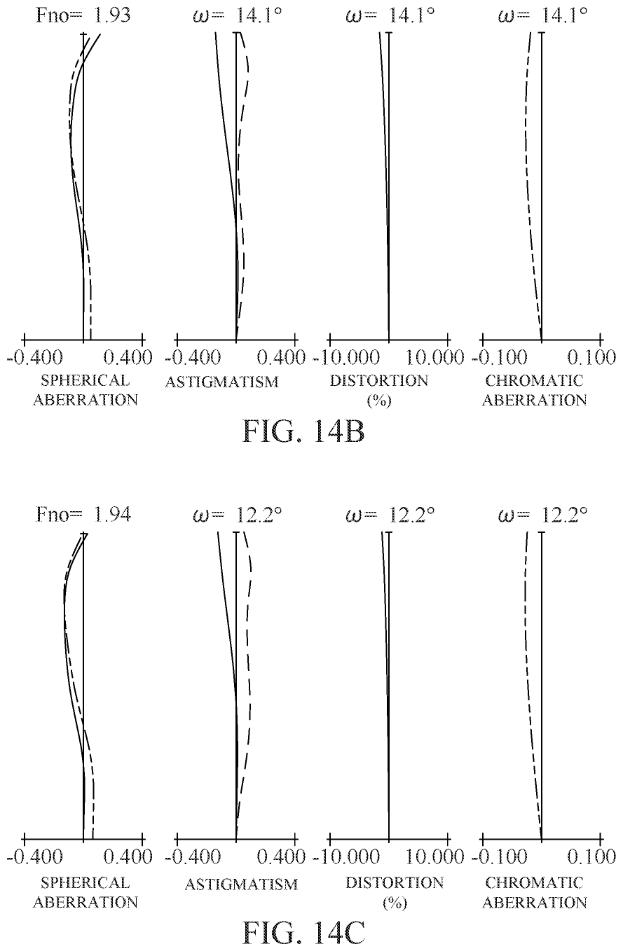

FIGS. 14A, 14B, and 14C illustrate longitudinal aberrations of the zoom lens according to this numerical example in an in-focus state on an infinity object. FIG. 14A illustrates the longitudinal aberration at the wide-angle end, FIG. 14B illustrates the longitudinal aberration at the intermediate zoom position (focal length of 59.0 mm), and FIG. 14C illustrates the longitudinal aberration at the telephoto end.

[symbol] Numerical Example 1

[symbol]

UNIT: mm
SURFACE DATA

| | | | | | | Effective |
|---|---|---|---|---|---|---|
| Surface No | r | d | nd | νd | θgF | Diameter |
| 1* | 644.897 | 2.60 | 1.80400 | 46.5 | 0.5577 | 79.73 |
| 2 | 33.369 | 23.86 | | | | 58.06 |
| 3 | −90.973 | 1.90 | 1.76385 | 48.5 | 0.5589 | 56.41 |
| 4 | 91.011 | 6.96 | | | | 55.81 |
| 5 | 123.555 | 8.61 | 1.84669 | 23.9 | 0.6207 | 60.71 |
| 6 | −285.240 | 5.18 | | | | 61.27 |
| 7* | 122.670 | 11.96 | 1.59522 | 67.7 | 0.5442 | 63.03 |
| 8 | −97.381 | 8.91 | | | | 63.22 |
| 9 | 940.284 | 2.10 | 1.80518 | 25.4 | 0.6157 | 58.73 |
| 10 | 55.773 | 10.24 | 1.43875 | 94.7 | 0.5340 | 57.08 |
| 11 | 624.207 | 0.21 | | | | 58.16 |
| 12 | 118.976 | 14.11 | 1.71300 | 54.0 | 0.5467 | 60.32 |
| 13 | −75.273 | (variable) | | | | 60.78 |
| 14 | 314.166 | 1.25 | 1.49700 | 81.5 | 0.5375 | 35.20 |
| 15 | 42.734 | 5.40 | | | | 33.76 |
| 16 | −142.949 | 1.25 | 1.83481 | 42.7 | 0.5648 | 33.68 |
| 17 | 57.815 | 4.01 | 1.80808 | 22.7 | 0.6305 | 33.96 |
| 18 | −767.184 | 6.35 | | | | 34.04 |
| 19 | −46.855 | 1.25 | 1.78800 | 47.4 | 0.5559 | 34.32 |
| 20 | −87.301 | (variable) | | | | 35.37 |
| 21 | −156.007 | 1.40 | 1.49700 | 81.5 | 0.5375 | 36.23 |
| 22 | 573.996 | (variable) | | | | 37.13 |
| 23(aperture stop) | ∞ | 1.00 | | | | 38.81 |
| 24 | 75.963 | 6.09 | 1.80610 | 40.9 | 0.5713 | 40.83 |
| 25* | −270.027 | (variable) | | | | 40.89 |
| 26 | −977.134 | 1.50 | 1.85478 | 24.8 | 0.6122 | 40.83 |
| 27 | 45.645 | 9.42 | 1.58313 | 59.4 | 0.5434 | 40.95 |
| 28 | −90.116 | 1.77 | | | | 41.39 |
| 29 | 77.127 | 14.32 | 1.80808 | 22.7 | 0.6305 | 41.72 |
| 30 | −34.347 | 1.50 | 1.95375 | 32.3 | 0.5905 | 40.64 |
| 31 | 206.955 | 2.21 | | | | 39.80 |
| 32 | 85.711 | 8.41 | 1.49700 | 81.5 | 0.5375 | 39.82 |
| 33 | −52.566 | 0.95 | | | | 39.48 |
| 34 | 53.738 | 7.46 | 1.58913 | 61.1 | 0.5407 | 35.89 |
| 35 | −89.761 | 1.25 | 1.85478 | 24.8 | 0.6122 | 34.82 |
| 36 | 34.790 | 3.72 | | | | 32.84 |
| 37 | 62.459 | 4.97 | 1.69350 | 53.2 | 0.5473 | 33.64 |
| 38 | −223.021 | (variable) | | | | 33.65 |
| Image Plane | ∞ | | | | | |

ASPHERIC DATA
1st Surface
K = 0.00000e+00 A 4 = 3.15551e−06 A 6 = −1.71560e−09 A 8 = 1.17327e−12
A10 = −6.92071e−16 A12 = 3.30975e−19 A14 = −1.05433e−22 A16 = 1.56810e−26
7th Surface
K = 0.00000e+00 A 4 = −1.59446e−06 A 6 = 5.75097e−10 A 8 = −1.02748e−12
A10 = 1.64653e−15 A12 = −1.52139e−18 A14 = 7.42738e−22 A16 = −1.46518e−25
25th Surface
K = 0.00000e+00 A 4 = 1.36851e−06 A 6 = 2.21160e−10 A 8 = −2.92464e−13

VARIOUS DATA
ZOOM RATIO 2.39

| | WIDE | MIDDLE | TELE |
|---|---|---|---|
| Focal Length | 14.49 | 28.27 | 34.65 |
| Fno. | 1.62 | 1.62 | 1.62 |
| Half Angle of View (°) | 45.61 | 27.63 | 23.13 |
| Image Height | 14.80 | 14.80 | 14.80 |
| Overall Lens Length | 283.79 | 283.79 | 283.79 |
| BF | 41.51 | 41.51 | 41.51 |
| d13 | 1.40 | 40.14 | 48.94 |
| d20 | 30.26 | 2.07 | 1.44 |
| d22 | 3.47 | 8.48 | 3.50 |
| d25 | 25.03 | 9.48 | 6.28 |
| d38 | 41.51 | 41.51 | 41.51 |

Lens Unit Data

| Lens | Starting | Focal | Lens Structure | Front Principal | Rear Principal |
|---|---|---|---|---|---|
| Unit | Surface | Length | Length | Point Position | Point Position |
| 1 | 1 | 49.73 | 96.65 | 58.02 | 79.52 |
| 2 | 14 | −40.55 | 19.51 | 6.32 | −9.09 |
| 3 | 21 | −245.94 | 1.40 | 0.20 | −0.73 |
| 4 | 23 | 73.70 | 7.09 | 1.74 | −2.65 |
| 5 | 26 | 63.99 | 57.48 | 18.88 | −19.96 |

[symbol] Numerical Example 2

[symbol]

UNIT: mm
SURFACE DATA

| | | | | | | Effective |
|---|---|---|---|---|---|---|
| Surface No | r | d | nd | νd | θgF | Diameter |
| 1 | 5081.742 | 6.32 | 1.58913 | 61.1 | 0.5407 | 88.83 |
| 2 | −251.488 | 0.20 | | | | 87.42 |
| 3 | −1268.615 | 2.90 | 1.69680 | 55.5 | 0.5434 | 82.49 |
| 4 | 151.530 | 26.99 | | | | 76.55 |
| 5 | −121.477 | 2.35 | 1.64000 | 60.1 | 0.5370 | 63.68 |
| 6 | 113.503 | 5.07 | 1.84669 | 23.9 | 0.6203 | 63.27 |
| 7 | 269.893 | 4.12 | | | | 63.56 |
| 8 | 452.671 | 8.86 | 1.49700 | 81.5 | 0.5375 | 65.56 |
| 9 | −112.404 | 0.31 | | | | 66.42 |
| 10 | 179.758 | 2.30 | 1.84669 | 23.9 | 0.6203 | 68.01 |
| 11 | 80.127 | 12.67 | 1.49700 | 81.5 | 0.5375 | 67.49 |
| 12 | −211.001 | 0.19 | | | | 67.80 |
| 13 | 76.820 | 9.40 | 1.71300 | 53.9 | 0.5462 | 68.07 |
| 14 | 400.932 | (variable) | | | | 66.97 |
| 15 | 1561.649 | 1.30 | 1.53775 | 74.7 | 0.5392 | 37.31 |
| 16 | 42.794 | 4.60 | | | | 35.50 |
| 17 | −562.104 | 1.20 | 1.65412 | 39.7 | 0.5737 | 35.46 |
| 18 | 39.945 | 4.33 | 1.80808 | 22.7 | 0.6305 | 35.35 |
| 19 | 119.864 | 5.01 | | | | 35.20 |
| 20 | −51.508 | 1.30 | 1.56883 | 56.4 | 0.5489 | 35.23 |
| 21 | −288.082 | (variable) | | | | 36.36 |
| 22 | −74.531 | 1.40 | 1.43875 | 94.7 | 0.5340 | 37.44 |
| 23 | 2560.699 | (variable) | | | | 39.11 |
| 24(aperture stop) | ∞ | 1.28 | | | | 40.76 |
| 25 | 85.098 | 6.29 | 1.89190 | 37.1 | 0.5780 | 43.40 |
| 26* | −193.036 | (variable) | | | | 43.55 |
| 27 | 419.313 | 1.40 | 1.85478 | 24.8 | 0.6122 | 43.54 |
| 28 | 52.368 | 11.21 | 1.58913 | 61.1 | 0.5407 | 43.27 |
| 29 | −71.461 | 1.00 | | | | 43.58 |
| 30 | 43.000 | 10.10 | 1.43875 | 94.7 | 0.5340 | 41.38 |
| 31 | −106.638 | 0.31 | | | | 39.99 |
| 32 | −94.172 | 1.40 | 1.74077 | 27.8 | 0.6095 | 39.94 |
| 33 | 30.647 | 8.33 | 1.65160 | 58.5 | 0.5390 | 37.09 |
| 34 | 278.773 | 0.83 | | | | 36.49 |
| 35 | 51.027 | 10.51 | 1.89286 | 20.4 | 0.6393 | 37.06 |
| 36 | −60.627 | 1.30 | 1.72047 | 34.7 | 0.5834 | 35.95 |
| 37 | 29.687 | 4.20 | | | | 32.76 |
| 38 | 62.653 | 3.79 | 1.67003 | 47.2 | 0.5627 | 33.29 |
| 39 | −5140.232 | (variable) | | | | 33.25 |
| Image Plane | ∞ | | | | | |

ASPHERIC DATA
26th Surface
K = 0.00000e+00 A 4 = 1.21831e−06 A 6 = −2.29212e−11 A 8 = −7.40535e−14

VARIOUS DATA
ZOOM RATIO 2.89

| | WIDE | MIDDLE | TELE |
|---|---|---|---|
| Focal Length | 32.03 | 74.95 | 92.69 |
| Fno. | 1.61 | 1.61 | 1.61 |
| Half Angle of View (°) | 24.80 | 11.17 | 9.07 |
| Image Height | 14.80 | 14.80 | 14.80 |
| Overall Lens Length | 284.58 | 284.58 | 284.58 |
| BF | 41.37 | 41.37 | 41.37 |
| d14 | 4.10 | 47.25 | 55.10 |
| d21 | 37.05 | 4.43 | 4.55 |
| d23 | 2.84 | 7.35 | 2.62 |
| d26 | 36.47 | 21.43 | 18.19 |
| d39 | 41.37 | 41.37 | 41.37 |

Lens Unit Data

| Lens | Starting | Focal | Lens Structure | Front Principal | Rear Principal |
|---|---|---|---|---|---|
| Unit | Surface | Length | Length | Point Position | Point Position |
| 1 | 1 | 108.63 | 81.67 | 67.62 | 16.18 |
| 2 | 15 | −36.63 | 17.74 | 6.42 | −7.18 |
| 3 | 22 | −164.63 | 1.40 | 0.03 | −0.94 |
| 4 | 24 | 66.51 | 7.57 | 2.30 | −2.32 |
| 5 | 27 | 67.73 | 54.37 | 10.77 | −25.27 |

[symbol] Numerical Example 3

[symbol]

UNIT: mm
SURFACE DATA

| | | | | | | Effective |
|---|---|---|---|---|---|---|
| Surface No | r | d | nd | νd | θgF | Diameter |
| 1 | −8114.129 | 6.42 | 1.67270 | 32.1 | 0.5988 | 96.04 |
| 2 | −231.798 | 0.20 | | | | 95.16 |
| 3 | −1496.878 | 3.00 | 1.88300 | 40.8 | 0.5667 | 88.28 |
| 4 | 190.788 | 27.10 | | | | 82.99 |
| 5 | −120.735 | 2.40 | 1.88300 | 40.8 | 0.5667 | 72.63 |
| 6 | 155.606 | 5.37 | 1.85478 | 24.8 | 0.6122 | 73.76 |
| 7 | 1035.502 | 1.99 | | | | 74.07 |
| 8 | 886.111 | 7.94 | 1.69680 | 55.5 | 0.5434 | 74.99 |
| 9 | −130.552 | 0.29 | | | | 75.33 |
| 10 | 153.821 | 2.50 | 1.85478 | 24.8 | 0.6122 | 74.78 |
| 11 | 74.621 | 13.95 | 1.52841 | 76.5 | 0.5396 | 72.86 |
| 12 | −293.898 | 0.68 | | | | 72.69 |
| 13* | 93.466 | 8.08 | 1.76385 | 48.5 | 0.5589 | 70.80 |
| 14 | 1138.478 | (variable) | | | | 70.28 |
| 15 | 2168.746 | 1.50 | 1.76385 | 48.5 | 0.5589 | 46.78 |
| 16 | 48.310 | (variable) | | | | 42.37 |
| 17 | −159.336 | 1.50 | 1.53775 | 74.7 | 0.5392 | 38.01 |
| 18 | 34.229 | 9.93 | 1.85478 | 24.8 | 0.6122 | 39.43 |
| 19 | −167.193 | 3.55 | | | | 39.14 |
| 20 | −107.478 | 1.50 | 1.88300 | 40.8 | 0.5667 | 37.84 |
| 21 | 210.959 | (variable) | | | | 37.63 |
| 22 | −59.317 | 0.66 | 1.89286 | 20.4 | 0.6393 | 37.72 |
| 23 | −64.554 | 1.50 | 1.80100 | 35.0 | 0.5864 | 38.03 |
| 24 | 138.696 | (variable) | | | | 39.96 |
| 25(aperture | ∞ | 0.99 | | | | 40.00 |
| stop) | | | | | | |
| 26* | 257.583 | 5.69 | 1.76385 | 48.5 | 0.5589 | 41.45 |
| 27 | −76.606 | 0.20 | | | | 42.45 |
| 28 | 61.967 | 13.57 | 1.81600 | 46.6 | 0.5568 | 45.34 |
| 29 | −43.228 | 1.50 | 1.78880 | 28.4 | 0.6009 | 44.89 |
| 30 | 104.831 | (variable) | | | | 43.17 |
| 31 | −662.556 | 1.50 | 1.89286 | 20.4 | 0.6393 | 43.45 |
| 32 | 53.238 | 8.93 | 1.43875 | 94.9 | 0.5340 | 43.74 |
| 33 | −115.345 | 0.20 | | | | 44.51 |
| 34 | 128.222 | 6.50 | 2.00100 | 29.1 | 0.5997 | 46.11 |
| 35 | −248.127 | 0.20 | | | | 46.08 |
| 36 | 51.842 | 10.18 | 1.89286 | 20.4 | 0.6393 | 44.74 |
| 37 | −83.149 | 1.30 | 1.79952 | 42.2 | 0.5672 | 43.85 |
| 38 | −754.752 | 2.01 | | | | 42.31 |
| 39 | −742.792 | 1.30 | 1.85478 | 24.8 | 0.6122 | 40.71 |
| 40 | 23.000 | 8.74 | 1.81600 | 46.6 | 0.5568 | 36.69 |
| 41 | 37.094 | 3.06 | | | | 35.34 |
| 42 | 78.512 | 7.08 | 1.70300 | 52.4 | 0.5506 | 35.51 |
| 43 | −54.162 | 1.30 | 1.72047 | 34.7 | 0.5834 | 35.44 |
| 44 | −246.393 | (variable) | | | | 35.36 |
| Image Plane | ∞ | | | | | |

ASPHERIC DATA
13th Surface
K = 0.00000e+00 A 4 = 1.95975e−08 A 6 = −9.34765e−12 A 8 = 7.77140e−15
26th Surface
K = 0.00000e+00 A 4 = −1.42418e−06 A 6 = 4.48185e−11 A 8 = −4.04862e−13

VARIOUS DATA
ZOOM RATIO 2.88

| | WIDE | MIDDLE | TELE |
|---|---|---|---|
| Focal Length | 31.20 | 70.00 | 89.83 |
| Fno. | 1.51 | 1.51 | 1.51 |
| Half Angle of View (°) | 25.38 | 11.94 | 9.36 |
| Image Height | 14.80 | 14.80 | 14.80 |
| Overall Lens Length | 300.00 | 300.00 | 300.00 |
| BF | 39.00 | 39.00 | 39.00 |
| d14 | 1.00 | 48.60 | 59.46 |
| d16 | 24.48 | 7.51 | 7.02 |
| d21 | 16.63 | 6.17 | 5.42 |
| d24 | 7.78 | 4.39 | 1.48 |
| d30 | 36.80 | 20.01 | 13.30 |
| d44 | 39.00 | 39.00 | 39.00 |

Lens Unit Data

| Lens | Starting | Focal | Lens Structure | Front Principal | Rear Principal |
|---|---|---|---|---|---|
| Unit | Surface | Length | Length | Point Position | Point Position |
| 1 | 1 | 117.85 | 79.93 | 67.28 | 18.35 |
| 2 | 15 | −64.39 | 1.50 | 0.87 | 0.02 |
| 3 | 17 | −1995.20 | 16.48 | 164.55 | 142.32 |
| 4 | 22 | −50.94 | 2.16 | 0.32 | −0.85 |
| 5 | 25 | 48.60 | 21.94 | 0.96 | −11.07 |
| 6 | 31 | 60.31 | 52.30 | 7.64 | −23.41 |

[symbol] Numerical Example 4

[symbol]

UNIT: mm
SURFACE DATA

| | | | | | | Effective |
|---|---|---|---|---|---|---|
| Surface No | r | d | nd | νd | θgF | Diameter |
| 1 | 15446.921 | 3.00 | 1.88300 | 40.8 | 0.5667 | 90.37 |
| 2 | 405.326 | 8.15 | | | | 88.86 |
| 3 | −191.400 | 4.24 | 1.68893 | 31.1 | 0.6004 | 88.70 |
| 4 | −138.921 | 27.63 | | | | 88.71 |
| 5 | −154.831 | 2.40 | 1.88300 | 40.8 | 0.5667 | 73.68 |
| 6 | 162.051 | 5.18 | 1.85478 | 24.8 | 0.6122 | 73.51 |
| 7 | 1130.150 | 2.00 | | | | 73.50 |
| 8 | 272.683 | 7.92 | 1.67790 | 55.3 | 0.5472 | 73.92 |
| 9 | −182.278 | 0.30 | | | | 73.94 |
| 10 | 260.340 | 2.50 | 1.85478 | 24.8 | 0.6122 | 72.20 |
| 11 | 81.731 | 11.79 | 1.59522 | 67.7 | 0.5442 | 71.30 |
| 12 | −409.945 | 0.20 | | | | 71.37 |
| 13* | 84.644 | 7.76 | 1.76385 | 48.5 | 0.5589 | 70.86 |
| 14 | 373.856 | (variable) | | | | 70.18 |
| 15 | 441.538 | 1.50 | 1.76385 | 48.5 | 0.5589 | 44.74 |
| 16 | 47.409 | 9.14 | | | | 42.47 |
| 17 | −122.483 | 1.50 | 1.53775 | 74.7 | 0.5392 | 42.65 |
| 18 | 58.968 | 5.71 | 1.84666 | 23.8 | 0.6205 | 43.98 |
| 19 | 993.664 | 5.11 | | | | 43.99 |
| 20 | −57.619 | 1.50 | 1.88300 | 40.8 | 0.5667 | 44.01 |
| 21 | −93.214 | (variable) | | | | 45.26 |
| 22 | −95.167 | 4.05 | 1.89286 | 20.4 | 0.6393 | 45.74 |
| 23 | −56.801 | 1.50 | 1.74951 | 35.3 | 0.5818 | 46.49 |
| 24 | −3608.909 | (variable) | | | | 48.82 |
| 25* | 197.832 | 8.59 | 1.76385 | 48.5 | 0.5589 | 56.62 |
| 26 | −89.346 | 0.20 | | | | 57.36 |
| 27 | 47.245 | 15.93 | 1.81600 | 46.6 | 0.5568 | 57.64 |
| 28 | −140.939 | 1.50 | 1.77047 | 29.7 | 0.5951 | 55.49 |
| 29 | 43.389 | (variable) | | | | 47.82 |
| 30(aperture | ∞ | 1.00 | | | | 47.22 |
| stop) | | | | | | |
| 31 | 119.133 | 1.50 | 1.85896 | 22.7 | 0.6284 | 46.50 |
| 32 | 34.407 | 12.62 | 1.43875 | 94.9 | 0.5340 | 44.30 |
| 33 | −262.296 | 1.00 | | | | 44.62 |
| 34 | 53.491 | 11.65 | 1.89286 | 20.4 | 0.6393 | 45.00 |
| 35 | −67.792 | 1.30 | 1.79952 | 42.2 | 0.5672 | 43.78 |
| 36 | −184.343 | 0.20 | | | | 42.03 |
| 37 | 1292.097 | 3.95 | 1.90525 | 35.0 | 0.5848 | 40.16 |
| 38 | −201.759 | 0.19 | | | | 38.51 |
| 39 | −289.968 | 1.30 | 1.85478 | 24.8 | 0.6122 | 37.70 |
| 40 | 23.513 | 6.36 | 1.81600 | 46.6 | 0.5568 | 32.36 |
| 41 | 35.000 | 8.48 | | | | 30.30 |
| 42 | 84.391 | 4.03 | 1.70300 | 52.4 | 0.5506 | 28.13 |
| 43 | −92.504 | 1.30 | 1.76182 | 26.5 | 0.6136 | 28.22 |
| 44 | −246.393 | (variable) | | | | 28.35 |
| Image Plane | ∞ | | | | | |

ASPHERIC DATA
13th Surface
K = 0.00000e+00 A 4 = 8.35376e−11 A 6 = 6.50747e−12 A 8 = −2.28970e−15
25th Surface
K = 0.00000e+00 A 4 = −9.74982e−07 A 6 = 5.76975e−11 A 8 = −4.71573e−14

VARIOUS DATA
ZOOM RATIO 2.50

| | WIDE | MIDDLE | TELE |
|---|---|---|---|
| Focal Length | 40.00 | 85.00 | 99.98 |
| Fno. | 1.55 | 1.55 | 1.55 |
| Half Angle of View (°) | 20.30 | 9.88 | 8.42 |
| Image Height | 14.80 | 14.80 | 14.80 |
| Overall Lens Length | 298.07 | 298.07 | 298.07 |
| BF | 39.00 | 39.00 | 39.00 |
| d14 | 1.08 | 37.55 | 42.94 |
| d21 | 39.05 | 5.02 | 1.50 |
| d24 | 14.65 | 13.80 | 10.52 |
| d29 | 10.10 | 8.51 | 9.93 |
| d44 | 39.00 | 39.00 | 39.00 |

Lens Unit Data

| Lens | Starting | Focal | Lens Structure | Front Principal | Rear Principal |
|---|---|---|---|---|---|
| Unit | Surface | Length | Length | Point Position | Point Position |
| 1 | 1 | 112.66 | 83.07 | 64.99 | 7.80 |
| 2 | 15 | −46.60 | 24.46 | 5.36 | −13.51 |
| 3 | 22 | −151.37 | 5.55 | −0.94 | −3.94 |
| 4 | 25 | 58.68 | 26.22 | −6.25 | −17.76 |
| 5 | 30 | 101.39 | 54.88 | 15.11 | −23.19 |

[symbol] Numerical Example 5

[symbol]

UNIT: mm
SURFACE DATA

| | | | | | | Effective |
|---|---|---|---|---|---|---|
| Surface No | r | d | nd | νd | θgF | Diameter |
| 1* | 312.448 | 2.00 | 1.75500 | 52.3 | 0.5474 | 89.82 |
| 2 | 50.421 | 13.82 | | | | 74.55 |
| 3 | 221.003 | 3.00 | 1.64000 | 60.1 | 0.5370 | 74.28 |
| 4 | 86.704 | 6.97 | | | | 70.91 |
| 5 | 341.505 | 1.50 | 1.75500 | 52.3 | 0.5474 | 71.50 |
| 6 | 450.844 | 16.24 | | | | 71.20 |
| 7 | −85.028 | 2.40 | 1.88300 | 40.8 | 0.5667 | 68.79 |
| 8 | 223.697 | 11.02 | 1.85478 | 24.8 | 0.6122 | 73.83 |
| 9 | −230.434 | 5.18 | | | | 76.02 |
| 10* | 195.072 | 15.71 | 1.67790 | 55.3 | 0.5472 | 83.09 |
| 11 | −98.447 | 0.30 | | | | 83.44 |
| 12 | 208.488 | 2.50 | 1.85478 | 24.8 | 0.6122 | 78.22 |
| 13 | 70.912 | 15.66 | 1.59522 | 67.7 | 0.5442 | 74.76 |
| 14 | −267.299 | 0.20 | | | | 74.38 |
| 15 | 102.237 | 5.85 | 1.76385 | 48.5 | 0.5589 | 70.62 |
| 16 | 328.022 | (variable) | | | | 69.85 |
| 17 | 64.400 | 1.50 | 1.76385 | 48.5 | 0.5589 | 50.63 |
| 18 | 43.984 | 6.51 | | | | 47.17 |
| 19 | 324.195 | 1.50 | 1.53775 | 74.7 | 0.5392 | 46.69 |
| 20 | 42.154 | 6.23 | 1.84666 | 23.8 | 0.6205 | 42.53 |
| 21 | 75.209 | 12.17 | | | | 40.19 |
| 22 | −59.372 | 1.50 | 1.88300 | 40.8 | 0.5667 | 36.85 |
| 23 | −164.741 | (variable) | | | | 37.71 |
| 24 | −168.264 | 2.40 | 1.89286 | 20.4 | 0.6393 | 38.13 |
| 25 | −82.260 | 1.50 | 1.80100 | 35.0 | 0.5864 | 38.44 |
| 26 | 536.092 | (variable) | | | | 39.44 |
| 27(aperture | ∞ | 1.00 | | | | 40.01 |
| stop) | | | | | | |
| 28* | −2199.188 | 2.03 | 1.76385 | 48.5 | 0.5589 | 40.34 |
| 29 | −167.834 | 0.20 | | | | 40.73 |
| 30 | 64.977 | 5.26 | 1.81600 | 46.6 | 0.5568 | 42.85 |
| 31 | 134.347 | 1.50 | 1.78880 | 28.4 | 0.6009 | 42.53 |
| 32 | 201.854 | (variable) | | | | 42.44 |
| 33 | −11468.833 | 1.50 | 1.89286 | 20.4 | 0.6393 | 42.44 |
| 34 | 47.225 | 9.17 | 1.43875 | 94.9 | 0.5340 | 42.44 |
| 35 | −140.011 | 0.22 | | | | 43.29 |
| 36 | 135.345 | 3.80 | 1.95375 | 32.3 | 0.5905 | 44.63 |
| 37 | −448.704 | 0.20 | | | | 44.65 |
| 38 | 60.658 | 7.85 | 1.89286 | 20.4 | 0.6393 | 44.31 |
| 39 | −148.110 | 1.30 | 1.79952 | 42.2 | 0.5672 | 43.49 |
| 40 | −183.642 | 2.96 | | | | 42.75 |
| 41 | 550.682 | 1.30 | 1.85478 | 24.8 | 0.6122 | 37.60 |
| 42 | 24.732 | 4.38 | 1.81600 | 46.6 | 0.5568 | 33.63 |
| 43 | 35.000 | 1.90 | | | | 33.13 |
| 44 | 51.654 | 13.54 | 1.65100 | 56.2 | 0.5420 | 33.35 |
| 45 | −27.745 | 1.30 | 1.67300 | 38.3 | 0.5757 | 33.24 |
| 46 | −246.393 | (variable) | | | | 33.24 |
| Image Plane | ∞ | | | | | |

ASPHERIC DATA
1st Surface
K = 0.00000e+00 A 4 = 5.77227e−07 A 6 = −7.21328e−11 A 8 = 4.12128e−15
10th Surface
K = 0.00000e+00 A 4 = −1.13652e−07 A 6 = 1.26341e−11 A 8 = 4.69582e−16
28th Surface
K = 0.00000e+00 A 4 = −1.42113e−06 A 6 = −8.35085e−11 A 8 = −6.54663e−13

VARIOUS DATA
ZOOM RATIO 2.50

| | WIDE | MIDDLE | TELE |
|---|---|---|---|
| Focal Length | 18.00 | 38.00 | 44.99 |
| FNO. | 1.51 | 1.51 | 1.51 |
| Half Angle of View (°) | 39.43 | 21.28 | 18.21 |
| Image Height | 14.80 | 14.80 | 14.80 |
| Overall Lens Length | 307.86 | 307.86 | 307.86 |
| BF | 39.00 | 39.00 | 39.00 |
| d16 | 0.99 | 54.69 | 63.95 |
| d23 | 47.20 | 5.19 | 1.50 |
| d26 | 1.48 | 4.76 | 1.49 |
| d32 | 24.12 | 9.14 | 6.85 |
| d46 | 39.00 | 39.00 | 39.00 |

Lens Unit Data

| Lens | Starting | Focal | Lens Structure | Front Principal | Rear Principal |
|---|---|---|---|---|---|
| Unit | Surface | Length | Length | Point Position | Point Position |
| 1 | 1 | 81.81 | 102.35 | 79.97 | 95.42 |
| 2 | 17 | −55.66 | 29.42 | 16.73 | −6.96 |
| 3 | 24 | −175.34 | 3.90 | 0.29 | −1.80 |
| 4 | 27 | 77.07 | 9.99 | 1.14 | −4.86 |
| 5 | 33 | 61.77 | 49.42 | 11.24 | −19.72 |

[symbol] Numerical Example 6

[symbol]

UNIT: mm
SURFACE DATA

| | | | | | | Effective |
|---|---|---|---|---|---|---|
| Surface No | R | d | nd | νd | θgF | Diameter |
| 1 | 4400.000 | 6.32 | 1.58913 | 61.1 | 0.5407 | 87.83 |
| 2 | −251.120 | 0.20 | | | | 86.40 |
| 3 | −1293.513 | 2.90 | 1.69680 | 55.5 | 0.5434 | 81.62 |
| 4 | 152.105 | 26.99 | | | | 75.84 |
| 5 | −121.944 | 2.35 | 1.64000 | 60.1 | 0.5370 | 62.99 |
| 6 | 112.212 | 5.07 | 1.84669 | 23.9 | 0.6203 | 62.85 |
| 7 | 266.014 | 4.12 | | | | 63.30 |
| 8 | 448.600 | 8.86 | 1.49700 | 81.5 | 0.5375 | 65.28 |
| 9 | −113.502 | 0.31 | | | | 66.16 |
| 10 | 183.105 | 2.31 | 1.84669 | 23.9 | 0.6203 | 67.71 |
| 11 | 80.314 | 12.66 | 1.49700 | 81.5 | 0.5375 | 67.22 |
| 12 | −207.315 | 0.22 | | | | 67.54 |
| 13 | 77.012 | 9.41 | 1.71300 | 53.9 | 0.5462 | 67.84 |
| 14 | 415.213 | (variable) | | | | 66.74 |
| 15 | 1965.996 | 1.31 | 1.53775 | 74.7 | 0.5392 | 37.20 |
| 16 | 42.913 | 4.61 | | | | 35.40 |
| 17 | −588.623 | 1.20 | 1.65412 | 39.7 | 0.5737 | 35.37 |
| 18 | 40.000 | 4.33 | 1.80808 | 22.7 | 0.6305 | 35.26 |
| 19 | 121.137 | 5.01 | | | | 35.10 |
| 20 | −51.513 | 1.31 | 1.56883 | 56.4 | 0.5489 | 35.14 |
| 21 | −300.000 | (variable) | | | | 36.27 |
| 22 | −75.995 | 1.40 | 1.43875 | 94.7 | 0.5340 | 37.36 |
| 23 | 2400.000 | (variable) | | | | 38.99 |
| 24(aperture | ∞ | 1.28 | | | | 40.69 |
| stop) | | | | | | |
| 25 | 85.125 | 6.29 | 1.89190 | 37.1 | 0.5780 | 43.31 |
| 26* | −192.853 | (variable) | | | | 43.46 |
| 27 | 331.981 | 8.69 | 1.79952 | 42.2 | 0.5675 | 43.37 |
| 28 | −73.363 | 5.02 | | | | 43.09 |
| 29 | −61.252 | 1.50 | 1.75520 | 27.5 | 0.6103 | 39.79 |
| 30 | 37.497 | 10.00 | 1.55200 | 70.7 | 0.5421 | 39.35 |
| 31 | −135.167 | 0.99 | | | | 39.70 |
| 32 | 41.726 | 10.10 | 1.49700 | 81.7 | 0.5378 | 39.85 |
| 33 | −91.017 | 1.35 | 1.67300 | 38.3 | 0.5757 | 38.86 |
| 34 | 45.630 | 2.75 | | | | 37.01 |
| 35 | 63.011 | 6.00 | 1.76385 | 48.5 | 0.5589 | 37.30 |
| 36 | −199.892 | 1.77 | | | | 36.91 |
| 37 | 76.817 | 10.34 | 1.89286 | 20.4 | 0.6393 | 36.40 |
| 38 | −49.929 | 0.01 | 1.55540 | 45.2 | 0.5639 | 35.35 |
| 39 | −49.929 | 1.20 | 1.78880 | 28.4 | 0.6009 | 35.35 |
| 40 | 32.903 | 3.49 | | | | 32.92 |
| 41 | 60.423 | 4.68 | 1.67790 | 55.4 | 0.5434 | 33.57 |
| 42 | −275.927 | (variable) | | | | 33.61 |
| Image Plane | ∞ | | | | | |

ASPHERIC DATA
26th Surface
K = 0.00000e+00 A 4 = 1.21831e−06 A 6 = −2.29212e−11 A 8 = −7.40535e−14

VARIOUS DATA
ZOOM RATIO 2.89

| | WIDE | MIDDLE | TELE |
|---|---|---|---|
| Focal Length | 32.23 | 75.24 | 93.05 |
| FNO. | 1.63 | 1.62 | 1.62 |
| Half Angle of View (°) | 24.67 | 11.13 | 9.04 |
| Image Height | 14.80 | 14.80 | 14.80 |
| Overall Lens Length | 284.58 | 284.58 | 284.58 |
| BF | 41.46 | 41.46 | 41.46 |
| d14 | 4.10 | 47.25 | 55.10 |
| d21 | 37.05 | 4.43 | 4.55 |
| d23 | 2.84 | 7.43 | 2.65 |
| d26 | 22.79 | 7.67 | 4.47 |
| d42 | 41.46 | 41.46 | 41.46 |

Lens Unit Data

| Lens | Starting | Focal | Lens Structure | Front Principal | Rear Principal |
|---|---|---|---|---|---|
| Unit | Surface | Length | Length | Point Position | Point Position |
| 1 | 1 | 108.78 | 81.71 | 67.68 | 16.08 |
| 2 | 15 | −36.63 | 17.76 | 6.43 | −7.18 |
| 3 | 22 | −167.44 | 1.40 | 0.03 | −0.94 |
| 4 | 24 | 66.51 | 7.57 | 2.31 | −2.32 |
| 5 | 27 | 68.13 | 67.89 | 25.64 | −25.17 |

[symbol] Numerical Example 7

[symbol]

UNIT: mm
SURFACE DATA

| | | | | | | Effective |
|---|---|---|---|---|---|---|
| Surface No | r | d | nd | νd | θgF | Diameter |
| 1* | 171.586 | 2.90 | 1.77250 | 49.6 | 0.5520 | 91.20 |
| 2 | 48.604 | 26.87 | | | | 75.16 |
| 3 | −92.247 | 2.40 | 1.55032 | 75.5 | 0.5405 | 74.52 |
| 4 | 794.162 | 0.54 | | | | 74.63 |
| 5 | 88.583 | 4.90 | 1.53996 | 59.5 | 0.5441 | 75.15 |
| 6 | 142.917 | 2.95 | | | | 74.73 |
| 7 | 140.067 | 13.62 | 1.43700 | 95.1 | 0.5326 | 74.31 |
| 8 | −129.481 | 0.12 | | | | 73.44 |
| 9 | 155.096 | 2.40 | 1.84666 | 23.8 | 0.6205 | 67.05 |
| 10 | 99.119 | 13.90 | | | | 64.64 |
| 11 | 62.266 | 13.05 | 1.43700 | 95.1 | 0.5326 | 66.80 |
| 12 | 943.907 | 0.50 | | | | 66.41 |
| 13 | 421.237 | 2.42 | 1.51823 | 58.9 | 0.5457 | 66.27 |
| 14 | 114.429 | 10.47 | 1.43700 | 95.1 | 0.5326 | 65.51 |
| 15 | −202.764 | 0.12 | | | | 65.20 |
| 16* | 80.530 | 5.29 | 1.57099 | 50.8 | 0.5588 | 62.79 |
| 17 | 291.985 | (variable) | | | | 62.19 |
| 18* | 111.494 | 1.00 | 1.90366 | 31.3 | 0.5946 | 34.46 |
| 19 | 29.395 | 6.69 | | | | 31.01 |
| 20 | −97.122 | 1.01 | 1.49700 | 81.5 | 0.5375 | 30.44 |
| 21 | 33.129 | 5.64 | 2.00069 | 25.5 | 0.6136 | 32.04 |
| 22 | 2505.016 | 3.55 | | | | 31.94 |
| 23 | −44.468 | 1.05 | 1.75520 | 27.5 | 0.6103 | 31.88 |
| 24 | −44.872 | 1.01 | 1.75500 | 52.3 | 0.5474 | 32.15 |
| 25 | 297.805 | (variable) | | | | 33.31 |
| 26 | 502.322 | 4.42 | 1.43700 | 95.1 | 0.5326 | 34.10 |
| 27 | −53.910 | 1.00 | 1.85896 | 22.7 | 0.6284 | 34.57 |
| 28 | −62.721 | (variable) | | | | 35.14 |
| 29(aperture | ∞ | 1.50 | | | | 36.33 |
| stop) | | | | | | |
| 30 | 163.512 | 3.23 | 1.88300 | 40.8 | 0.5667 | 37.10 |
| 31 | −177.575 | 0.12 | | | | 37.16 |
| 32 | 50.203 | 9.75 | 1.48749 | 70.2 | 0.5300 | 37.65 |
| 33 | −53.521 | 1.00 | 1.84850 | 43.8 | 0.5620 | 37.51 |
| 34 | 149.207 | (variable) | | | | 38.10 |
| 35 | −1445.424 | 2.00 | 1.85478 | 24.8 | 0.6122 | 34.12 |
| 36 | 62.851 | 8.51 | 1.58313 | 59.4 | 0.5434 | 35.22 |
| 37 | −279.727 | 4.32 | | | | 37.33 |
| 38 | 257.190 | 9.93 | 1.89286 | 20.4 | 0.6393 | 40.50 |
| 39 | −73.931 | 1.45 | 1.95375 | 32.3 | 0.5898 | 41.75 |
| 40 | −80.444 | 5.27 | | | | 42.10 |
| 41 | 66.382 | 6.48 | 1.43875 | 94.7 | 0.5340 | 41.01 |
| 42 | −925.723 | 0.25 | | | | 40.21 |
| 43 | 41.952 | 7.52 | 1.51633 | 64.1 | 0.5353 | 38.18 |
| 44 | −95.014 | 1.25 | 1.84666 | 23.8 | 0.6205 | 37.54 |
| 45 | 29.211 | 2.99 | | | | 34.08 |
| 46 | 29.840 | 5.26 | 1.70300 | 52.4 | 0.5506 | 35.84 |
| 47 | 59.621 | (variable) | | | | 35.17 |
| Image Plane | ∞ | | | | | |

ASPHERIC DATA
1st Surface
K = 0.00000e+00 A 4 = 3.59336e−07 A 6 = −4.81490e−11 A 8 = 4.75719e−14
A10 = −8.43358e−17 A12 = 9.49237e−20 A14 = −6.16206e−23 A16 = 2.27900e−26
A18 = −4.50977e−30 A20 = 3.73117e−34
16th Surface
K = 0.00000e+00 A 4 = −7.65361e−07 A 6 = 1.76164e−10 A 8 = −1.75032e−12
A10 = 4.18201e−15 A12 = −6.46239e−18 A14 = 6.23132e−21 A16 = −3.67293e−24
A18 = 1.20868e−27 A20 = −1.70119e−31
18th Surface
K = 0.00000e+00 A 4 = 3.01818e−07 A 6 = −7.72571e−10 A 8 = 6.14162e−12
A10 = −1.78972e−14 A12 = 2.28854e−17

VARIOUS DATA
ZOOM RATIO 3.45

| | WIDE | MIDDLE | TELE |
|---|---|---|---|
| Focal Length | 19.87 | 58.99 | 68.58 |
| FNO. | 1.94 | 1.93 | 1.94 |
| Half Angle of View (°) | 36.68 | 14.08 | 12.18 |
| Image Height | 14.80 | 14.80 | 14.80 |
| Overall Lens Length | 305.44 | 305.44 | 305.44 |
| BF | 38.00 | 37.87 | 38.01 |
| d17 | 1.34 | 59.47 | 64.27 |
| d25 | 1.60 | 3.93 | 1.59 |
| d28 | 44.78 | 4.25 | 1.38 |
| d34 | 21.05 | 1.25 | 1.54 |
| d47 | 38.00 | 37.87 | 38.01 |

Lens Unit Data

| Lens | Starting | Focal | Lens Structure | Front Principal | Rear Principal |
|---|---|---|---|---|---|
| Unit | Surface | Length | Length | Point Position | Point Position |
| 1 | 1 | 79.23 | 102.46 | 76.08 | 52.18 |
| 2 | 18 | −28.29 | 19.95 | 5.97 | −7.73 |
| 3 | 26 | 147.63 | 5.42 | 3.78 | 0.16 |
| 4 | 29 | 107.22 | 15.60 | −7.02 | −16.01 |
| 5 | 35 | 63.91 | 55.23 | 10.13 | −24.09 |

TABLE-1

| NUMERICAL | | SURFACE | | | | ngp + |
|---|---|---|---|---|---|---|
| EXAMPLE | LENS | NO | ngp | νgp | dndTp | 0.0046 × νgp |
| 1 | 21 | 37 | 1.69350 | 53.2 | 5.5 | 1.938 |
| 2 | 19 | 33 | 1.65160 | 58.5 | 4.4 | 1.921 |
| 3 | 25 | 42 | 1.70300 | 52.4 | 7.7 | 1.944 |
| 4 | 25 | 42 | 1.70300 | 52.4 | 7.7 | 1.944 |
| 5 | 26 | 44 | 1.65100 | 56.2 | 6.6 | 1.910 |
| 6 | 24 | 41 | 1.67790 | 55.4 | 6.0 | 1.933 |
| 7 | 27 | 46 | 1.70300 | 52.4 | 7.7 | 1.944 |

(The numerical value of dndTp is stated without “×10⁻⁶.”)

TABLE 2

| NUMER- | | | | | θ gFud + |
|---|---|---|---|---|---|
| ICAL | | SURFACE | | | 0.001625 × |
| EXAMPLE | LENS | NO | ν ud | θ gFud | ν ud |
| 1 | 18 | 32 | 81.5 | 0.5375 | 0.670 |
| 2 | 17 | 30 | 94.7 | 0.5340 | 0.688 |
| 3 | 19 | 32 | 94.9 | 0.5340 | 0.688 |
| 4 | 19 | 32 | 94.9 | 0.5340 | 0.688 |
| 5 | 20 | 34 | 94.9 | 0.5340 | 0.688 |
| 6 | 17 | 30 | 70.7 | 0.5421 | 0.657 |
| | 18 | 32 | 81.7 | 0.5378 | 0.671 |
| 7 | 24 | 41 | 94.7 | 0.5340 | 0.688 |

| | | TABLE-3 | | | | | | |
|---|---|---|---|---|---|---|---|---|
| | | NUMERICAL EXAMPLE | | | | | | |
| INEQUALITY | | 1 | 2 | 3 | 4 | 5 | 6 | 7 |
| (1) | ngp | 1.69350 | 1.65160 | 1.70300 | 1.70300 | 1.65100 | 1.67790 | 1.70300 |
| (2) | dndTp | 5.5 | 4.4 | 7.7 | 7.7 | 6.6 | 6.0 | 7.7 |
| (3) | ngp + 0.0046νgp | 1.9382 | 1.9207 | 1.9440 | 1.9440 | 1.9095 | 1.9327 | 1.9440 |
| (4) | dr/fr | 0.90 | 0.80 | 0.87 | 0.54 | 0.80 | 1.00 | 0.86 |
| (5) | νud | 81.50 | 94.70 | 94.90 | 94.90 | 94.90 | 81.70 | 94.70 |
| (6) | θgFud + | 0.6699 | 0.6879 | 0.6882 | 0.6882 | 0.6882 | 0.6706 | 0.6879 |
| | 0.001625νud | | | | | | | |
| (7) | fr/Dopen | 1.85 | 1.66 | 1.51 | 2.15 | 1.54 | 1.67 | 1.76 |
| (8) | f1/fw | 3.43 | 3.39 | 3.78 | 2.82 | 4.54 | 3.38 | 3.99 |
| (9) | ft/f1 | 0.70 | 0.85 | 0.76 | 0.89 | 0.55 | 0.86 | 0.87 |
| (10) | dndTpave | 1.05 | 1.22 | 1.93 | 2.13 | 1.75 | 2.00 | 1.45 |
| | ngp | 1.69350 | 1.65160 | 1.70300 | 1.70300 | 1.65100 | 1.67790 | 1.70300 |
| | dndTp | 5.5 | 4.4 | 7.7 | 7.7 | 6.5 | 6.0 | 7.7 |
| | νgp | 53.2 | 58.5 | 52.4 | 52.4 | 56.2 | 55.4 | 52.4 |
| | dr | 57.48 | 54.37 | 52.30 | 54.88 | 49.42 | 67.89 | 55.23 |
| | fr | 63.99 | 67.73 | 60.31 | 101.39 | 61.77 | 68.13 | 63.91 |
| | νud | 81.5 | 94.7 | 94.9 | 94.9 | 94.9 | 81.7 | 94.7 |
| | θgFud | 0.5375 | 0.5340 | 0.5340 | 0.5340 | 0.5340 | 0.5378 | 0.5340 |
| | Dopen | 38.81 | 40.76 | 40.00 | 47.22 | 40.01 | 40.69 | 36.33 |

(The numerical value of dndTp is stated without “×10⁻⁶.”)

### Image Pickup Apparatus

FIG. 13 illustrates the configuration of an image pickup apparatus (camera system) having one of the zoom lenses according to Examples 1 to 7 as an imaging optical system. In FIG. 13, reference numeral 101 denotes one of the zoom lenses according to Examples 1 to 7. Reference numeral 124 denotes a camera body. The zoom lens 101 is attachable to and detachable from the camera body 124. Reference numeral 125 denotes an image pickup apparatus including the zoom lens 101 and the camera body 124 attached to the zoom lens 101.

The zoom lens 101 includes a first lens unit F, a zoom unit LZ, and an Nth lens unit R for imaging. At least part of the first lens unit F (focus sub-lens unit) moves during focusing. The zoom unit LZ includes a moving lens unit that moves during zooming illustrated in Examples 1 to 7. SP denotes an aperture stop. Drive mechanisms 114 and 115, such as helicoids and cams, drive the focus sub-lens unit during focusing and the zoom unit LZ during zooming, respectively.

Reference numerals 116 to 118 denote actuators such as motors for electrically driving the driving mechanisms 114 and 115 and the aperture stop SP. Reference numerals 119 to 121 denote detectors such as encoders, potentiometers or photosensors for detecting the positions of the focus sub-lens unit, the position of the zoom unit LZ and the position of the aperture stop SP (aperture diameter). In the camera body 124, reference numeral 109 denotes a glass block corresponding to an optical filter inside the camera body 124, and reference numeral 110 denotes an image sensor such as a CCD sensor or CMOS sensor for imaging an object through the zoom lens 101.

Control units 111 and 122, such as CPUs, control various operations of the camera body and the zoom lens 101, respectively.

Thus, using the zoom lens according to each example in an image pickup apparatus can realize the image pickup apparatus that is compact and lightweight, has high optical performance over the entire zoom range, and can suppress focus shift caused by temperature changes.

For example, each example can provide a zoom lens and an image pickup apparatus that are beneficial in terms of small size, high optical performance, and focus stability against temperature changes.

While the disclosure has been described with reference to embodiments, it is to be understood that the disclosure is not limited to the disclosed embodiments. The scope of the following claims is to be accorded the broadest interpretation so as to encompass all such modifications and equivalent structures and functions.

This application claims the benefit of Japanese Patent Application Nos. 2022-149803, filed on Sep. 21, 2022, and 2023-103771, filed on Jun. 23, 2023, which are hereby incorporated by reference herein in their entirety.

What is claimed is:

1. A zoom lens in which a distance between adjacent lens units changes during zooming, the zoom lens comprising, in order from an object side to an image side:
a first lens unit fixed during zooming and having positive refractive power;
three or more moving lens units movable during zooming; and
a final lens unit fixed during zooming and having positive refractive power,
wherein at least part of the first lens unit moves during focusing,
wherein at least one of a moving lens unit closest to an image plane among the three or more moving lens units and the final lens unit includes a first lens having positive refractive power, and
wherein the following inequalities are satisfied:
1.60≤ngp≤1.73
4.1×10⁻⁶≤dndTp≤12.0×10⁻⁶
1.90≤ngp+0.0046×vgp
0.3≤dr/fr≤1.5
where ngp is a refractive index of the first lens for d-line, vgp is an Abbe number of the first lens based on the d-line, dndTp is a temperature coefficient of the refractive index of the first lens for the d-line from 20° C. to 40° C., dr is a distance on an optical axis from a lens surface closest to an object to a lens surface closest to the image plane in the final lens unit, and fr is a focal length of the final lens unit.

2. The zoom lens according to claim 1, wherein the final lens unit includes a second lens having positive refractive power, and
where the following inequalities are satisfied:
62≤νud
0.640≤θgFud+0.001625×νud≤0.700
where νud is an Abbe number of the second lens based on the d-line, and θgFud is a partial dispersion ratio of the second lens for g-line and F-line.

3. The zoom lens according to claim 1, wherein the first lens is included in the final lens unit.

4. The zoom lens according to claim 2, wherein the first lens is disposed closer to the image plane than the second lens.

5. The zoom lens according to claim 1, further comprising an aperture stop,
wherein the following inequality is satisfied:
1.00≤fr/Dopen≤2.4
where Dopen is an aperture diameter in an fully open state of the aperture stop.

6. The zoom lens according to claim 1, further comprising an aperture stop,
wherein the aperture stop moves during zooming.

7. The zoom lens according to claim 1, wherein the three or more moving lens units include three or four lens units.

8. The zoom lens according to claim 1, wherein the first lens unit includes five or more lenses.

9. The zoom lens according to claim 1, wherein the final lens unit includes three or more lenses.

10. The zoom lens according to claim 1, wherein the final lens unit includes ten or less lenses.

11. The zoom lens according to claim 2, wherein the second lens consists of a single lens in the final lens unit.

12. The zoom lens according to claim 1, wherein the following inequality is satisfied:
1.0≤fl/fw≤10.0
where fl is a focal length of the first lens unit, and fw is a focal length at a wide-angle end of the zoom lens.

13. The zoom lens according to claim 1, wherein the following inequality is satisfied:
0.3≤ft/fl≤1.2
where ft is a focal length at a telephoto end of the zoom lens.

14. The zoom lens according to claim 1, wherein the moving lens unit has two or more lens units each having negative refractive power.

15. The zoom lens according to claim 1, wherein the following inequality is satisfied:
−0.5≤dndTpave≤4.0
where dndTpave is an average temperature coefficient of the refractive index for the d-line from 20° C. to 40° C. of lenses having positive refractive power included in the final lens unit.

16. An image pickup apparatus comprising:
the zoom lens according to claim 1; and
an image sensor configured to image an object through the zoom lens.
